(19) United States
(12) Patent Application Publication
(10) Pub. No.: US 2018/0306894 A1
(43) Pub. Date: Oct. 25, 2018

(54) Supporting an Indication of a Location of an Object

(71) Applicant: Nokia Technologies Oy, Espoo (FI)

(72) Inventors: Olli Koskimies, Helsinki (FI); Joni Jantunen, Helsinki (FI); Veli-Matti Kolmonen, Espoo (FI); Hannu Laine, Espoo (FI); Ilari Teikari, Helsinki (FI)

(21) Appl. No.: 15/768,633

(22) PCT Filed: Oct. 22, 2015
(86) PCT No.: PCT/FI2015/050720

§ 371 Date: Apr. 16, 2018

(51) Int. Cl. G01S 5/02

(52) U.S. Cl. CPC G01S 5/0278; G01S 5/0252

(57) ABSTRACT

An apparatus assigns to a plurality of grid areas of a grid, the grid defined to virtually cover a positioning site, a probability that an object is located in the respective grid area. The probabilities are based at least on characteristics of wireless signals propagating in at least one direction between the object and devices distributed at the positioning site. The apparatus selects grid areas such that the total probability assigned to the selected grid areas at least reaches a predetermined probability. The apparatus determines a set of at least one virtual room, with the set containing selected grid areas, and provides an indication of the set of at least one virtual room as an estimated location of the object.

### FIELD OF THE DISCLOSURE

The invention relates to positioning and more specifically to supporting an indication of a location of an object to a user.

### BACKGROUND

Location based services are obtaining an increasing significance in mobile communications. It is already common practice to use mobile device tracking and services that are based on the position of a mobile device. With upcoming new standard-based short-range wireless technologies that will make it possible to locate objects or positions indoors with extremely high accuracy, it may be expected that the utilization of indoor locations and of relative locations between devices in different services and for interactions between devices will increase significantly.

The High Accuracy Indoor Positioning (HAIP) solution, for instance, makes use of a low energy feature of the Bluetooth® 4.0 specification that allows for an accuracy of one meter. The technology can also be extended to achieve an accuracy of 20 cm. The HAIP solution currently uses angle-of-arrival (AoA) measurements to determine the position of a Bluetooth transmitter. For supporting an angle-of-arrival estimation, the Bluetooth transmitter transmits AoA packets. Another device, which may be referred to as HAIP locator, comprises a plurality of directional antennas with different orientations, a radio frequency switch for switching between the antennas, a Bluetooth transceiver for receiving signals via the switch from a respective one of the antennas, and an angle of arrival estimation unit. The HAIP locator scans for AoA packets transmitted by Bluetooth transmitters and executes amplitude and phase sampling during reception of these packets. In addition, it executes antenna switching during the reception of the packets. The HAIP locator may then utilize the amplitude and phase samples, along with its own antenna array information, to estimate the angle-of-arrival of the packets from the Bluetooth transmitter. The angle-of-arrival estimated at several HAIP locators may then be used for determining the position of the Bluetooth transmitter.

However, while angle-of-arrival based positioning may be very accurate, it utilizes an antenna array in the HAIP locators, which increases cost and requires specialized hardware. HAIP locators also are densely installed, typically in 2-4 meter intervals, depending on the height of the ceiling of a positioning site.

In order to provide a less expensive alternative, a solution may be used instead, which relies on radio signal strength measurements at locators. These locators only need to be arranged densely enough to guarantee that a signal of a mobile transmitter that is to be located may always be heard by at least one locator using a single omnidirectional antenna. A positioning may be performed by directly estimating the distance between locators operating as receivers and the mobile transmitter based on the measured received signal strengths. Alternatively, a positioning may be performed by using a “fingerprinting” method. For a fingerprinting method, the received signal strength of signals transmitted by a mobile transmitter and measured by various locators while the mobile transmitter is located at a known position is recorded in advance as a respective signal strength pattern for various positions of one or more mobile transmitters throughout a positioning site. The position of a mobile transmitter may then be determined by comparing the received signal strengths for that mobile transmitter as measured by one or more locators to the pre-recorded signal strength patterns. Such a received signal strength based positioning may be accurate to a few meters.

Since radio signals penetrate walls, it may not always be possible to determine with certainty in which room a positioned mobile device is located when using a radio signal based positioning method of limited accuracy. Knowing the correct room in which an object is located may be useful in some use cases, though. This may be achieved through use of signal emitters that emit signals that do not pass through walls, for example signals that are based on infrared light or ultrasound. These emitters are called exciters. An exciter may be placed in each room of interest. An identifier of the room may be encoded in the signal. When a mobile device that is to be located receives such a signal, it may send the room identifier to a positioning backend for evaluation.

Since HAIP is accurate but expensive, and the approach relying on radio signal strength measurements is cheaper but less accurate, it is also possible to use a hybrid solution, for which a positioning site supports HAIP only in areas where accurate positioning is desired, and radio signal strength based positioning elsewhere. In this case, a mobile device that is to be located switches between HAIP positioning and radio signal strength based positioning depending on whether it is in a HAIP coverage area or not. In addition exciters may be used to enhance the room accuracy of radio signal strength based positioning.

### SUMMARY OF SOME EMBODIMENTS OF THE INVENTION

An example embodiment of a method is presented, which comprises assigning to a plurality of grid areas of a grid, the grid defined to virtually cover a positioning site, a probability that an object is located in the respective grid area, the probabilities being based at least on characteristics of wireless signals propagating in at least one direction between the object and devices distributed at the positioning site. The method further comprises selecting grid areas such that the total probability assigned to the selected grid areas at least reaches a predetermined probability. The method further comprises determining a set of at least one virtual room, with the set containing selected grid areas. The method further comprises providing an indication of the set of at least one virtual room as an estimated location of the object.

The method may be performed by an apparatus or in a distributed manner by a plurality of interacting apparatuses.

Moreover, an example embodiment of an apparatus is presented, which comprises means for causing an apparatus to perform the actions of any embodiment of the presented example method.

The means of the apparatus may be implemented in hardware and/or software. They may comprise for instance a processor for executing computer program code for realizing the required functions, a memory storing the program code, or both. Alternatively, they may comprise for instance a circuit that is designed to realize the required functions, for instance implemented in a chipset or a chip, like an integrated circuit. In certain embodiments, the means of the presented apparatus are processing means.

Moreover, an example embodiment of an apparatus is presented, which comprises at least one processor and at least one memory including computer program code, the at least one memory and the computer program code configured to, with the at least one processor, cause at least one apparatus at least to perform the following: assign to a plurality of grid areas of a grid, the grid defined to virtually cover a positioning site, a probability that an object is located in the respective grid area, the probabilities being based at least on characteristics of wireless signals propagating in at least one direction between the object and devices distributed at the positioning site; select grid areas such that the total probability assigned to the selected grid areas at least reaches a predetermined probability; determine a set of at least one virtual room, with the set containing selected grid areas; and provide an indication of the set of at least one virtual room as an estimated location of the object.

Any of the described apparatuses may comprise only the indicated components or one or more additional components.

Moreover an example embodiment of a system is presented, which comprises any embodiment of any presented example apparatus. Optionally, the system comprises in addition at least one of the devices distributed at the positioning site.

Moreover an example embodiment of a non-transitory computer readable storage medium is presented, in which computer program code is stored. The computer program code causes at least one apparatus to perform the actions of any embodiment of the presented example method when executed by a processor.

The computer readable storage medium may be for example a disk or a memory or the like. The computer program code may be stored in the computer readable storage medium in the form of instructions encoding the computer-readable storage medium. The computer readable storage medium may be intended for taking part in the operation of a device, like an internal or external hard disk of a computer, or be intended for distribution of the program code, like an optical disc.

It is to be understood that any embodiment of the computer program code by itself has to be considered an example embodiment of the invention as well. The computer program code could also be distributed to several computer readable storage mediums.

In certain embodiments, any of the presented methods is an information providing method, and any of the presented apparatuses is an information providing apparatus.

In certain embodiments, any of the presented methods is a method for supporting an indication of a location of an object. In certain embodiment, any of the presented apparatuses is an apparatus for supporting an indication of a location of an object.

Further, it is to be understood that the presentation of the invention in this section is merely exemplary and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an example embodiment of an apparatus;

FIG. 2 is a flow chart illustrating an example embodiment of a method;

FIG. 3 is a schematic block diagram of an example embodiment of a system;

FIG. 4 is a schematic block diagram of an example embodiment of an apparatus in the system of FIG. 3;

FIG. 5 is a flow chart illustrating an example embodiment of first operations in the system of FIG. 3;

FIG. 6 is a diagram illustrating an example detail of the operations of FIG. 5;

FIG. 7 is a diagram illustrating an example detail of the operations of FIG. 5;

FIG. 8 is a diagram illustrating an example detail of the operations of FIG. 5;

FIG. 9 is a diagram illustrating an example detail of the operations of FIG. 5;

FIG. 10 is a diagram illustrating an example detail of the operations of FIG. 5;

FIG. 11 is a diagram illustrating an example detail of the operations of FIG. 5;

FIG. 12 is a flow chart illustrating an example embodiment of further operations in the system of FIG. 3;

FIG. 13 is a diagram illustrating an example detail of the operations of FIG. 12;

FIG. 14 is a diagram illustrating an example detail of the operations of FIG. 12;

FIG. 15 is a flow chart illustrating a first example embodiment of an action of FIG. 12;

FIG. 16 is a diagram illustrating an example detail of the operation of FIG. 15;

FIG. 17 is a diagram illustrating an example detail of the operation of FIG. 15;

FIG. 18 is a diagram illustrating an example detail of the operation of FIG. 15;

FIG. 19 is a flow chart illustrating a second example embodiment of an action of FIG. 12;

FIG. 20 is a diagram illustrating an example detail of the operation of FIG. 19;

FIG. 21 is a diagram illustrating an example detail of the operation of FIG. 19;

FIG. 22 is a diagram illustrating an example detail of the operation of FIG. 19;

FIG. 23 is a diagram illustrating an example detail of the operation of FIG. 19;

FIG. 24 is a diagram illustrating an example detail of the operation of FIG. 19;

FIG. 25 is a flow chart illustrating a third example embodiment of an action of FIG. 12;

FIG. 26 is a diagram illustrating an example detail of the operation of FIG. 25;

FIG. 27 is a diagram illustrating an example detail of the operation of FIG. 25;

FIG. 28 is a flow chart illustrating a fourth example embodiment of an action of FIG. 12;

FIG. 29 is a diagram illustrating an example detail of the operation of FIG. 28;

FIG. 30 is a schematic block diagram of an example embodiment of an apparatus;

FIG. 31 is a schematic block diagram of an example embodiment of an apparatus; and

FIG. 32 schematically illustrates example removable storage devices.

### DETAILED DESCRIPTION OF THE FIGURES

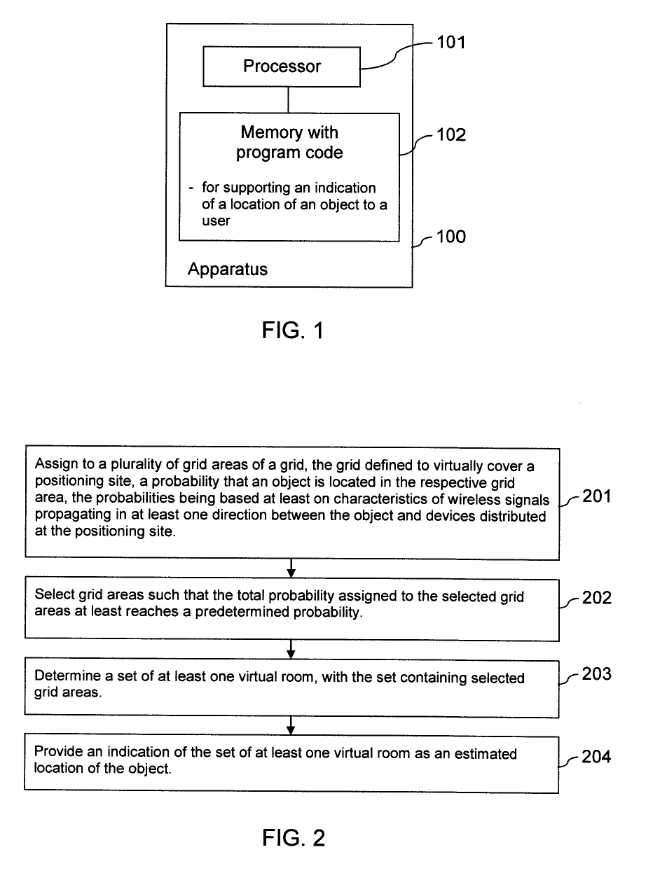

FIG. 1 is a schematic block diagram of an example embodiment of an apparatus 100 according to the invention. Apparatus 100 comprises a processor 101 and, linked to processor 101, a memory 102. Memory 102 stores computer program code for supporting an indication of a location of an object to a user. Processor 101 is configured to execute computer program code stored in memory 102 in order to cause an apparatus to perform desired actions.

Apparatus 100 may be a mobile device or a stationary device. A mobile device is configured to be moved when in operation. A stationary device is configured to be stationary when in operation and/or fixed to a particular location. Apparatus 100 may be for instance a user device, like a mobile communication device, a workstation computer or a tag, or a server. Apparatus 100 may equally be a module, like a chip, circuitry on a chip or a plug-in board, for a device. Optionally, apparatus 100 may comprise various other components, like a data interface, a user interface, a further memory, a further processor, etc.

An example operation of apparatus 100 will now be described with reference to the flow chart of FIG. 2. The operation is an example embodiment of a method according to the invention. Processor 101 and the program code stored in memory 102 cause an apparatus to perform the operation when program code is retrieved from memory 102 and executed by processor 101. The apparatus that is caused to perform the operation may be apparatus 100 or some other apparatus, for example but not necessarily a device comprising apparatus 100.

The apparatus assigns to a plurality of grid areas of a grid, the grid defined to virtually cover a positioning site, a probability that an object is located in the respective grid area. The probabilities are based at least on characteristics of wireless signals propagating in at least one direction between the object and devices distributed at the positioning site. (action 201) The devices may be distributed at fixed positions at the positioning site. It is to be understood, however, that the devices may also be mobile. They may be for instance portable or otherwise mobile devices that have capabilities to locate themselves with satisfying accuracy so that their position may not be fixed but known.

The apparatus furthermore selects grid areas such that the total probability assigned to the selected grid areas at least reaches a predetermined probability. (action 202) This is to be understood to cover as well embodiments in which the predetermined probability is required to be exceeded in any case.

The apparatus furthermore determines a set of at least one virtual room, with the set containing selected grid areas. (action 203)

The apparatus furthermore provides an indication of the set of at least one virtual room as an estimated location of the object. (action 204) The indication may be provided for internal or external use.

The invention proceeds from the consideration that in some environments, an enabled positioning may not be accurate enough to indicate the exact position of an object of interest. On the other hand, indicating simply a physical room as location, for example based on a map of a positioning site, may not be satisfactory, in particular if the room is fairly large.

Certain embodiments of the invention therefore provide that virtual rooms are used for indicating the position of an object at a positioning site. The object may be configured to receive wireless signals from devices distributed at the positioning site. The object may determine characteristics of the wireless signals. Alternatively or in addition, the object may be configured to transmit wireless signals, which may be received at devices distributed at the positioning site. In this case, these devices may determine characteristics of the wireless signals. The positioning site is covered by a virtual grid, and the characteristics of the wireless signals may be used for determining a probability that an object is located in any of the grid areas of the grid. Grid areas may then be selected such that the total probability that the object is located in one of the selected grids at least reaches a predetermined probability. The object may be indicated to be located in a virtual room or in a set of virtual rooms containing all or some of the selected grid areas.

Certain embodiments of the invention may have the effect that, with the use of virtual rooms, low-accuracy positioning information, or a combination of low-accuracy and high-accuracy position information, can be intuitively displayed at a higher accuracy than a physical room.

Apparatus 100 illustrated in FIG. 1 and the method illustrated in FIG. 2 may be implemented and refined in various ways.

In an example embodiment, grid areas may be selected such that the total probability assigned to the selected grid areas at least reaches a predetermined probability by selecting a minimum number of grid areas for which the sum of the assigned probabilities is one of larger than a predetermined limit and equal to or larger than a predetermined limit. This may be achieved, for example, by summing the probabilities assigned to grid areas in decreasing order of probability until the sum of the probabilities is one of larger than a predetermined limit and equal to or larger than a predetermined limit, and by selecting the grid areas of which the probabilities have been summed. A requirement that the predetermined limit has to be exceeded in any case by the sum of probabilities, or a requirement that it is already sufficient if the sum of probabilities is at least equal to the predetermined limit may be selected arbitrarily. In a possible alternative approach, grid areas may be selected such that the total probability assigned to the selected grid areas at least reaches a predetermined probability by summing the probabilities assigned to grid areas in increasing order of probability as long as the sum of the probabilities one of falls short of a predetermined limit and falls short of or is equal to a predetermined limit, and selecting the remaining grid areas. In a variation of the latter approach, it may also be possible to subtract the probabilities in increasing order from “1” as long as the sum of the probabilities one of exceeds a predetermined limit and exceeds or is equal to a predetermined limit, and to select the remaining grid areas.

The predetermined limit for the probability may be set to any desired value, for instance, though not exclusively, to any value between 0.9 and 0.99.

In an example embodiment, the determined set of at least one virtual room may be caused to be indicated to a user as an estimated location of the object. If the apparatus determining the at least one virtual room is or belongs to a user device, causing the indication of the at least one virtual room to the user may comprise highlighting the at least one virtual room on a display of the user device and/or outputting a name assigned to the virtual room via a loudspeaker of the user device. If the apparatus determining the at least one virtual room is or belongs to another device than a user device, for example a server, causing the indication of the at least one virtual room to the user may comprise causing a transmission of a corresponding indication to a user device.

In an example embodiment, the determined set of at least one virtual room may comprise at least one predetermined virtual room. An effect of using predetermined virtual rooms may be that they may be intuitive to human users and that they can be named. A naming of virtual rooms may allow displaying an estimated location textually as well, not only graphically, and/or presenting an estimated location in the form of audio output. An effect of using predetermined virtual rooms may further be that such virtual rooms can be used to easily define geofences. The determined set of at least one virtual room may comprise for instance at least one virtual room predetermined manually by a user to correspond to an area of the positioning site having a distinctive characteristic. Such a distinctive characteristic may be for instance a function of the area or an optical characteristic, like a predominant color. Furthermore, the determined set of at least one virtual room may comprise for instance at least one predetermined interleaving virtual room associated with a set of at least two primary virtual rooms, the at least two primary virtual rooms corresponding to a respective area of the positioning site having a distinctive characteristic. Furthermore, the determined set of at least one virtual room may comprise for instance at least one predetermined interleaving virtual room, the at least one interleaving virtual room covering at least a part of each of at least two adjacent primary virtual rooms, the at least two adjacent primary virtual rooms corresponding to a respective area of the positioning site having a distinctive characteristic. The use of predefined interleaving virtual rooms may have the effect that location information may be presented accurately also in cases where the correct primary virtual room cannot be determined reliably. Interleaving virtual rooms may be predetermined manually by a user as well. Alternatively, interleaving virtual rooms may also be created automatically based on user defined primary virtual rooms and, optionally be manually adjustable if needed, for instance to enable more complex layouts.

It has to be noted that a user configuring the system, for instance by defining predetermined virtual rooms, may be different from a user to whom an estimated location of an object may be indicated. A user configuring the system may be for instance an operator of a positioning system or a manager of a positioning site, while a user to which an indication of a location of an object is to be presented may be a private or professional end user. It is to be understood, however, that also an end user may define predetermined virtual rooms.

Alternatively or in addition to predetermined virtual rooms, the determined set of at least one virtual room may comprise at least one dynamically determined virtual room. An effect of defining virtual rooms dynamically may be that there is no need to manually define virtual rooms in advance or that fewer virtual rooms have to be defined manually in advance. An effect of defining virtual rooms dynamically may further be that a desired total probability of the indicated estimated location may be met quite well. The determined set of at least one virtual room may comprise for instance at least one virtual room dynamically determined as a combination of all selected grid areas. Such a variable shape may represent the desired total probability particularly precisely. Alternatively, the determined set of at least one virtual room may comprise for instance a virtual room dynamically determined as an area of predetermined shape containing all selected grid areas. A predetermined shape may be a rectangle, a square or any other desired shape. Using a predetermined shape like a rectangle for a virtual room may make a presentation of a virtual room on a display particularly easy to assess visually for a user.

For an example embodiment, it is assumed that at least two primary virtual rooms corresponding to a respective area of the positioning site having a distinctive characteristic have been predetermined. Determining a set of at least one virtual room, with the set containing selected grid areas, may then comprise determining whether one of the predetermined primary virtual rooms contains all selected grid areas. If it is determined that one of the predetermined primary virtual rooms contains all selected grid areas, providing an indication of the set of at least one virtual room as an estimated location of the object may comprise providing an indication of this one determined primary virtual room as an estimated location of the object. If it is determined that none of the predetermined primary virtual rooms contains all selected grid areas, an interleaving virtual room containing all selected grid areas may be generated dynamically. In case an interleaving virtual room is dynamically generated, providing an indication of the set of at least one virtual room as an estimated location of the object may comprise providing at least an indication of the dynamically generated interleaving virtual room as an estimated location of the object. This may have the effect that the task of a user configuring the system is limited to an intuitive definition of primary virtual rooms based on their characteristics, while the use of interleaving virtual rooms is supported nevertheless for the case that an estimated location cannot be mapped to one of these primary virtual rooms with sufficient probability.

For another example embodiment, it is assumed that at least two primary virtual rooms corresponding to a respective area of the positioning site having a distinctive characteristic have been predetermined and that at least one interleaving virtual room including at least parts of at least two of the at least two primary virtual rooms has been predetermined. Determining a set of at least one virtual room, with the set containing selected grid areas, may then comprise determining whether one of the predetermined virtual rooms—primary or interleaving—contains all selected grid areas. If it is determined that one of the predetermined virtual rooms contains all selected grid areas, providing an indication of the set of at least one virtual room as an estimated location of the object may comprise providing an indication of this one determined virtual room as an estimated location of the object. If it is determined that none of the predetermined virtual rooms contains all selected grid areas, an interleaving virtual room containing all selected grid areas may be generated dynamically. In case an interleaving virtual room is generated dynamically, providing an indication of the set of at least one virtual room as an estimated location of the object may comprise providing at least an indication of the dynamically generated interleaving virtual room as an estimated location of the object. This may have the effect that for most cases, the presentation of an estimated location may be controlled by a user configuring the system. Nevertheless, in case a situation arises that was not envisaged when predetermining primary and interleaving virtual rooms, a good representation of the estimated location of the object may be presented to a user nevertheless.

For another example embodiment, it is assumed again that at least two primary virtual rooms corresponding to a respective area of the positioning site having a distinctive characteristic have been predetermined and that at least one interleaving virtual room including at least parts of at least two of the at least two primary virtual rooms has been predetermined. Determining a set of at least one virtual room, with the set containing selected grid areas, may then comprise determining whether one of the predetermined primary virtual rooms contains all selected grid areas. If it is determined that one of the predetermined primary virtual rooms contains all selected grid areas, providing an indication of the set of at least one virtual room as an estimated location of the object may comprise providing an indication of this one determined primary virtual room as an estimated location of the object. If none of the predetermined primary virtual rooms contains all selected grid areas, it may be determined whether an interleaving virtual room has been predetermined which includes at least a part of each predetermined primary virtual room containing at least one of the selected grid areas. If it is determined that such an interleaving virtual room has been predetermined, at least an indication of the predetermined interleaving room may be provided as an estimated location of the object. If it is determined in contrast that such an interleaving virtual room has not been predetermined, an interleaving virtual room may be dynamically generated, and at least an indication of the dynamically generated interleaving virtual room may be provided as an estimated location of the object. It may be noted that in this embodiment a determined predetermined interleaving room may not necessarily be required to contain all selected grid areas.

For another example embodiment, it is assumed that at least two primary virtual rooms corresponding to a respective area of the positioning site having a distinctive characteristic have been predetermined and that at least one interleaving virtual room has been defined for a set of at least two predetermined primary virtual rooms. Determining a set of at least one virtual room, with the set containing selected grid areas, may then comprise determining whether one of the predetermined primary virtual rooms contains all selected grid areas. If it is determined in a particular situation that one of the predetermined primary virtual rooms contains all selected grid areas, providing an indication of the set of at least one virtual room as an estimated location of the object may comprise providing an indication of this one determined primary virtual room as an estimated location of the object. If it is determined in another situation that none of the predetermined virtual rooms contains all selected grid areas, it may be determined whether an interleaving virtual room has been defined for a set of all primary virtual rooms containing at least one selected grid area. If such an interleaving virtual room has been defined, an indication of this interleaving virtual room may be provided as an estimated location of the object. It may be noted that in this case, the defined interleaving rooms do necessarily have to have any defined shape. They may also be defined as a label, like “Interleaving Room” that is to be presented on a screen somewhere in a region that may be associated by a user with the set of primary rooms containing at least one of the selected grid areas. Or they may be defined by a descriptive name, like “In the area of Room 1, Room 2 and Room 3” or “Middle Room” etc., that may be presented on a screen or output via a loudspeaker. Optionally, the interleaving virtual room may have a shape for the purpose of presentation on a display, though. It is to be understood that if it is determined that no suitable interleaving virtual room has been defined, also in this example embodiment an interleaving virtual room may be generated dynamically, and at least an indication of such a dynamically generated interleaving virtual room may be provided as an estimated location of the object.

Interleaving virtual rooms lacking a defined shape (or having a purely presentational shape that is independent of selected grid areas) may also be generated automatically. Such interleaving virtual rooms may be generated automatically as predetermined interleaving virtual rooms when the system is being configured. Optionally, such automatically generated interleaving virtual rooms may also be provided as a starting point for a manual process of defining predetermined interleaving virtual rooms. Further optionally, some parameters for a predetermined interleaving virtual room may be generated automatically as a supplement of a partial definition of a predetermined interleaving virtual room by a user. For instance, when a user inputs a name for an interleaving virtual room, the input of a location of placement of the name when presented on a display may be optional. For this case, an automatically selected location may be provided, which may or may not be adjusted by the user. Interleaving virtual rooms lacking a defined shape (or having a purely presentational shape that is independent of selected grid areas) may also be used when dynamically generating interleaving virtual rooms during a positioning process when no or no suitable predetermined interleaving virtual room is available.

An automatic generation of interleaving virtual rooms with or without defined shape may be implemented in various ways, some example aspects being summarized in the following: A label for an interleaving virtual room may be generated automatically, for instance by combining the labels of selected primary virtual rooms containing at least one selected grid area or by using the same, predetermined label for all automatically generated interleaving virtual rooms. The location of the label may be generated automatically, for instance by taking the average of the center points for the selected primary virtual rooms; or by taking the average of the center points of all grid squares that touch the borders of all the selected primary rooms; or by taking the center point of a predetermined shape (e.g. rectangle) that comprises all grid areas that touch the borders of all the selected primary rooms and as few other grid areas as possible; or by (dynamically) taking the average of the center points of the selected grid areas; or by (dynamically) taking the center point of a predetermined shape (e.g. rectangle) that comprises all selected grid areas and as few other grid areas as possible. The shape of an intermediate room that is to be presented on a display may be generated automatically, for instance by using the smallest possible shape of a predetermined type (e.g. rectangle or ellipse) that contains the center points of the selected primary rooms; or by using a predetermined shape (e.g. rectangle or ellipse) that comprises all grid areas that touch the borders of all the selected primary rooms and as few other grid areas as possible; or by using a combination (e.g. a union of) the shapes of all the selected primary rooms; or by (dynamically) using a predetermined shape (e.g. rectangle or ellipse) that comprises all selected grid areas and as few other grid areas as possible.

Using interleaving rooms may generally have the effect that a location of an object may be displayed accurately when the object would otherwise be on the border between two primary virtual rooms.

For an example embodiment, it is assumed that at least two primary virtual rooms corresponding to a respective area of the positioning site having a distinctive characteristic have been predetermined, that at least two of the predetermined primary virtual rooms are overlapping, and that different priorities have been assigned to the predetermined overlapping primary virtual rooms. In case at least two predetermined primary virtual rooms are determined, which each contains all selected grid areas, the determined virtual room with the highest assigned priority may then be selected. This may have the effect that always the most suitable virtual room may be indicated to a user. For example, in some constellations, it may be more efficient for a user if the smaller one of two overlapping virtual rooms is indicated.

In an example embodiment, the grid is defined to have grid areas of different sizes in different regions of the positioning site. This may have the effect that differences in coverage and capabilities of the devices distributed at the positioning site may be taken into account.

The probabilities that are assigned to the grid areas may be determined in any suitable manner. They may be based for instance on a radio map and/or be results of measurements on the wireless signals. Such results of measurements may comprise for instance an angle of arrival of wireless signals, a time-of-flight of wireless signals, a received signal strength value or a received signal strength indication of wireless signals and/or a signal strength pattern of wireless signals. In addition to results of measurements on wireless signals, also other factors may be taken into account, like structural elements of the positioning site and/or a predetermined heatmap indicating a frequency at which each grid area is entered by objects. Heatmaps are commonly used to display spatial data; for example, in a shop a heatmap might be used to display where customers typically walk.

In an example embodiment, the wireless signals comprise Bluetooth signals and/or Bluetooth Low Energy (BLE) signals and/or wireless local area network (WLAN) signals and/or infrared light signals and/or ultrasound signals. Only one kind of signals or any combination may be used. Considering infrared light signals and ultrasound signals may have the effect that they do not pass through walls. As a result they may be suited to delimit physical rooms precisely from each other.

In an example embodiment, the wireless signals are transmitted by distributed devices and received by the object and/or transmitted by the object and received by distributed devices. If wireless signals to and from the object are evaluated, the wireless signals as well as the distributed devices receiving the wireless signals and the distributed devices transmitting the wireless signals may be of different kinds.

In case wireless signals received at the object are evaluated, the object may perform an embodiment of the method according to the invention, or the object may provide results of measurements on the wireless signals to some other apparatus for performing the method according to the invention. This may take place directly or via some intermediate device, for instance via one of the devices distributed at the positioning site.

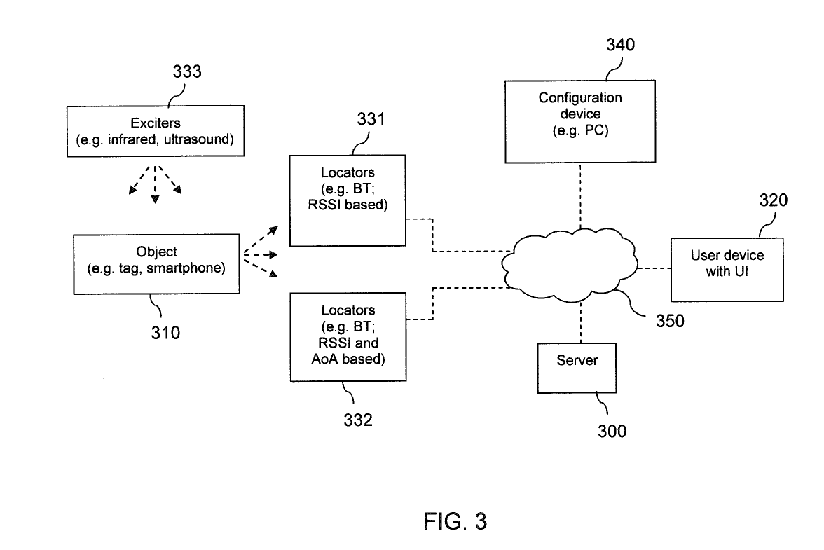

FIG. 3 is a schematic block diagram of an example embodiment of a system, which supports an intuitive presentation of a high accuracy estimate of a location of an object to a user.

The system comprises a server 300, an object 310 that is to be located, a user device 320, positioning support devices 331, 332, 333 and a configuration device 340.

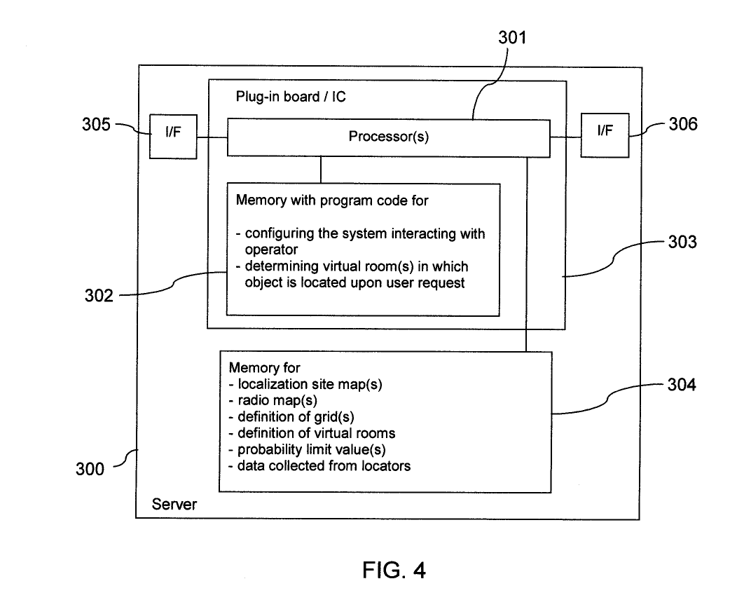

Server 300 may be provided for a particular positioning site, like a building, or for a plurality of positioning sites. Possible details of server 300 will be presented further below with reference to FIG. 4.

Positioning support devices 331, 332, 333 are distributed by way of example at fixed, known positions at the positioning site. Some of the positioning support devices may be locators 331, 332 that are implemented, for example, as microcontroller unit (MCU) and radio chip systems. They may comprise for instance a Bluetooth receiver or transceiver, optionally supporting BLE. They may be configured to scan for wireless signals from mobile objects and perform measurements on these signals. Some locators 331 may be provided to this end with an omnidirectional antenna and be configured determine an identifier of a mobile object included in the wireless signals and determine the received signal strength. Other locators 332 may comprise a plurality of directional antennas and a radio frequency switch. These locators 332 may be configured to determine an identifier of a mobile object included in the wireless signals and be enabled to determine the angle of arrival of the signal alternatively or in addition to the received signal strength. Locators 332 may be distributed more densely in selected areas, while locators 331 may be distributed less densely in the rest of the positioning site. Locators 331, 332 are configured to communicate with server 300. They may be linked to server 300 for instance via an Ethernet based local area network or be configured to communicate with server 300 for instance via a wireless local area network. In particular if server 300 is not located on the positioning site, the communication may also take place via a local intermediate server and the Internet. In some embodiments, locators 331, 332 may support a Bluetooth connection only and transmit any information to server 300 via a gateway. Locators 331, 332 may also be configured to receive messages including measurement results determined at object 310 from object 310 and forward the messages or the included content to server 300. Locators 331 may be for instance locators supporting radio signal strength measurements, and locators 332 may be for instance HAIP locators. Others of the positioning support devices may be exciters 333 that are able to transmit signals that do not penetrate through walls. Such exciters 333 may be configured for instance to transmit infrared signals or ultrasound signals. The signals may include an encoded identifier of the exciter 333 transmitting the signals or of the room in which the exciter is arranged.

It is to be understood that some or all of the positioning support devices 331, 332, 333 may also be configured to support other tasks than supporting a positioning of objects.

Object 310 may be any kind of mobile device that is configured to receive and transmit signals. It may be a tag that has no other function than enabling its positioning or it may be a more comprehensive device that supports unrelated functions in addition, like a smartphone. It may be configured to receive signals from exciters 333, for instance infrared or ultrasound signals, to extract an included identifier of the exciter or of the room or area in which the exciter is located and to provide the identifier to server 300, for instance via one of the locators 331, 332 or via some other access node. In addition, it may be configured to broadcast signals that may be received by locators 331, 332, for instance in the form of BLE advertisement signals. Object 310 may be carried by a person who may have to be located, like a child or a person suffering from dementia at a large positioning site, a sick person in a hospital who is linked in addition to some alerting function, etc. Alternatively, object 310 may be or be attached to a mobile device that has to be located regularly, like some medical equipment that is needed at various places in a hospital or some working equipment that is needed at various places in a factory.

User device 320 may be any type of communication device. It may be a mobile device, for example a smartphone or a tablet computer, or it may be a stationary device, like a desktop PC. It comprises a user interface that enables a user input, like a touchscreen or a keypad, and that enables a presentation of information to a user, including for example a display and/or a loudspeaker. It comprises a communication component that supports a communication with server 300. It is to be understood that user device 320 may comprise various other components in addition.

Configuration device 340 may be a personal computer of an operator of the system. Alternatively, it may be a device of some other person who is authorized to configure the system, like a customer of a service provider operating the system or a manager of the positioning site. Configuration device 340 may comprise a user interface and it supports communication with server 300. It may be connected to server 300 by wire or wirelessly or via the Internet.

Cloud 350 represents any possible link or network or combination of links and/or networks between server 300 on the one hand and locators 331, 332, configuration device 340 and user device 320 on the other hand, including for instance the Internet.

FIG. 4 is a schematic block diagram presenting example details of server 300 of FIG. 3.

Server 300 comprises a processor 301 that is linked to a first memory 302, to a second memory 304, to a first interface I/F 305 and to a second interface I/F 306.

Processor 301 is configured to execute computer program code, including computer program code stored in memory 302, in order to cause server 300 to perform desired actions.

Memory 302 stores computer program code for configuring the system in cooperation with an operator using configuration device 340. Memory 302 furthermore stores computer program code for determining virtual rooms in which an object is assumed to be located. Some of the program code in memory 302 may be similar to program code in memory 102. In addition, memory 302 may store computer program code configured to realize other functions. In addition, memory 302 may also store any kind of data.

Processor 301 and memory 302 may optionally belong to a plug-in board, a chip or an integrated circuit 303, which may comprise in addition various other components, for instance a further processor or memory.

Memory 304 is configured to store data, including for example map data for the location site or for several positioning sites, radio map data for the location site or for several positioning sites, a definition of a grid for the location site or for several positioning sites, a definition of virtual rooms for the location site or for several positioning sites, a probability limit value for the location site or for several positioning sites, and optionally a default probability limit value and/or other default values. Memory 304 may further be configured to store data collected from locators 331, 332. Memory 304 may be configured to store any other desired data as well. Memory 304 may be configured to store the indicated data in that it stores the data as data of a database, which defines a suitable structure for each of the indicated kind of data. Some or all of the data may also be stored in an external memory, which may be accessed by server 300 directly or via some other server.

Interface 305 is a component which enables server 300 to communicate with other devices, like mobile device 320, for instance via the Internet and some wireless communication network. It may also enable server 300 to communicate with other entities, like other servers, for instance via the Internet. Interfaces 305 may comprise for instance a TCP/IP (Transmission Control Protocol/Internet Protocol) socket. Interface 306 is a component which enables server 300 to communicate with other devices, like locators 331, 332 and configuration device 340. It may be for instance a local area network interface. It is to be understood that server 300 may comprise further interfaces, or that a single interface is used for all connections.

It is to be understood that server 300 may comprise various other components, like a user interface.

Component 303 or server 300 may be an example embodiment of an apparatus according to the invention.

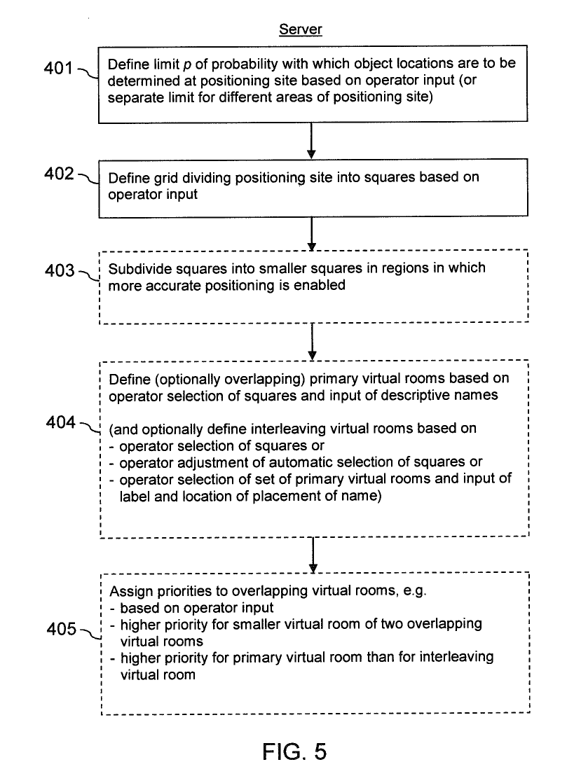

Example operations in the system of FIG. 3 for supporting a positioning of objects at a particular positioning site will now be described with reference to FIGS. 5 to 29.

FIG. 5 is a flow chart illustrating example configuration operations at server 300. Processor 301 and some of the program code stored in memory 302 may cause server 300 to perform the presented actions when corresponding program code is retrieved from memory 302 and executed by processor 301.

The configuration operations may be performed in collaboration with an operator using configuration device 340. For the positioning site, a map may be available in memory 304. The map may be retrieved for the configuration operations and presented to the operator on a display of configuration device 340.

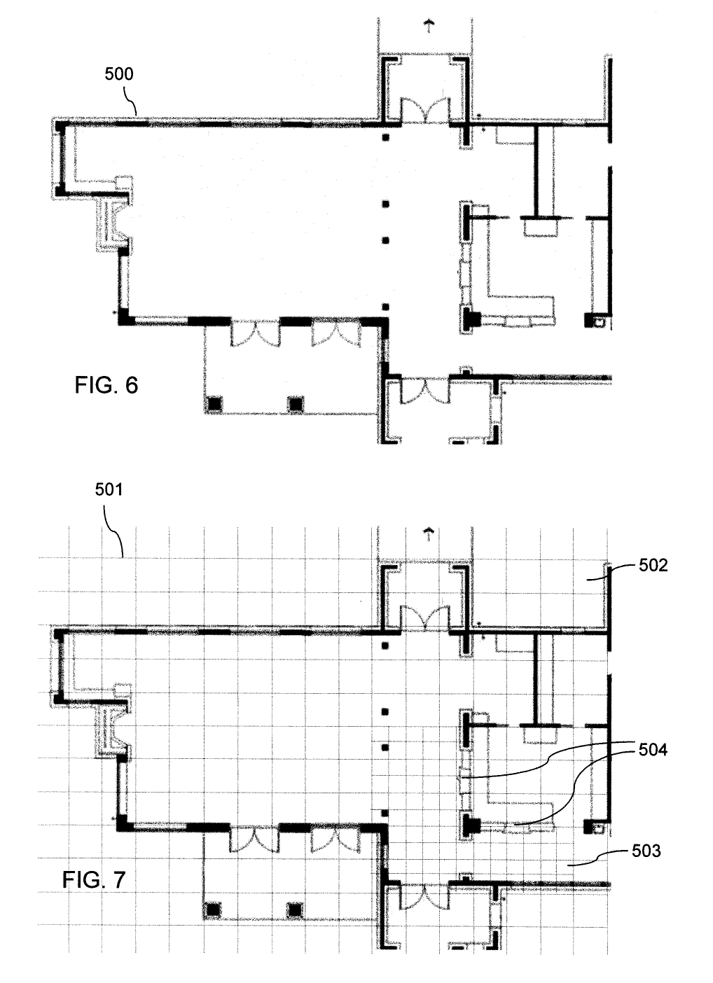

A part of an example map 500 is presented for the purpose of illustration in FIG. 6. By way of example, the positioning site is assumed to be a hospital, and the presented part of the map covers the entrance area of the hospital.

Server 300 first defines a limit p of a probability with which the location of objects are to be determined at the positioning site. There may be for instance a predetermined default limit p, which may be adjusted based on an input of the operator via configuration device 340. (action 401). Limit p represents the minimum acceptable probability that an object is located in an indicated area or at least in certain types of indicated areas. For instance, a default value could be set to p=0.99, which indicates that a 1% error rate is acceptable. An operator may decide for a particular positioning site that a 5% error rate is acceptable and set limit p to 0.95. Setting a lower value may result in some cases in a smaller indicated area, which may be preferred in some systems. In an alternative embodiment, different limits may be assigned to different areas of the positioning site. For instance, a separate limit may be assigned to each physical room and each open space, or even to smaller units. This may allow using for instance different accuracy requirements depending on the positioning technology used in different areas.

Next, server 300 defines a grid, which divides the positioning site into squares, the squares constituting example grid areas. (action 402) It is to be understood that other shapes of grid areas may be used as well, for instance rectangles or rhombuses.

The grid may be defined based on an input of the operator via configuration device 340 such that the squares are small enough that desired virtual rooms may later be defined in terms of which squares are included. Optionally, the operator may adjust a predefined default grid spacing to this end.

An example grid 501 with grid squares 502 overlaying the map 500 of FIG. 6 is illustrated in FIG. 7.

In areas in which a more accurate positioning of objects may be enabled, for instance due to closely spaced locators 332, a denser grid with smaller grid squares may be used. This may be accomplished for instance by subdividing each concerned grid square of the previously defined grid into four smaller squares. (action 403) This may again be based on an input of the operator.

Such smaller grids 503 are equally illustrated in FIG. 7. Locators 332 supporting an angle-of-arrival based positioning are assumed to be closely spaced in check-in areas 504 near a reception desk so that the queues in front of each counter can be followed in real time. Accordingly, the grid is defined to be denser in these areas in FIG. 7.

It is to be understood that the subdividing of a grid square into four sub-squares may be continued recursively, if needed, until a suitable size of squares has been obtained for each area. It is further to be understood that an original grid square may also be divided into a different number of sub-squares than 4, such as 9 (3×3 sub-grid) or 25 (5×5 sub-grid).

Server 300 may now support a definition of primary virtual rooms by the operator via configuration device 340. A primary virtual room may be defined as a set of grid squares and a virtual room may be defined simply by selecting arbitrary squares. A virtual room may be selected for example based on different functions that are assigned to different areas in a large room or space. A definition of the primary virtual room is stored by server 300 in memory 304. The operator may also assign a corresponding descriptive name to each primary virtual room, which may be stored by server 300 along with the definition of the primary virtual room. (action 404)

A virtual room may be defined by the operator for example by “painting” with a finger on the grid when displayed on a touch screen. For instance, by default, all squares could be set to a “not selected” value when starting to define a room. All squares touched by a user may then be turned “selected” until the operator lifts the finger from the screen, similar as with some conventional painting tools. The selected squares do not have to be connected. Squares may be deselected again in a corresponding manner. It is to be understood that squares for virtual rooms may also be selected in a different manner, for instance using a mouse.

It may be noted that the grid may be used in a similar manner for defining geofences instead on a touch-enabled device, such as a tablet or mobile phone. Geofences are defined coordinate boundaries which have a special significance. For example, a geofence may be used to define the area where a child is allowed to move, so that an alert may be generated when the child leaves the area. Geofences may for example be used to trigger some action when an object enters or leaves the geofence, or when a specific activity is performed within the geofence or outside the geofence. Such a geofence may be defined in some embodiments for instance by a user using user device 320 in communication with server 300 and without involvement of configuration device 340.

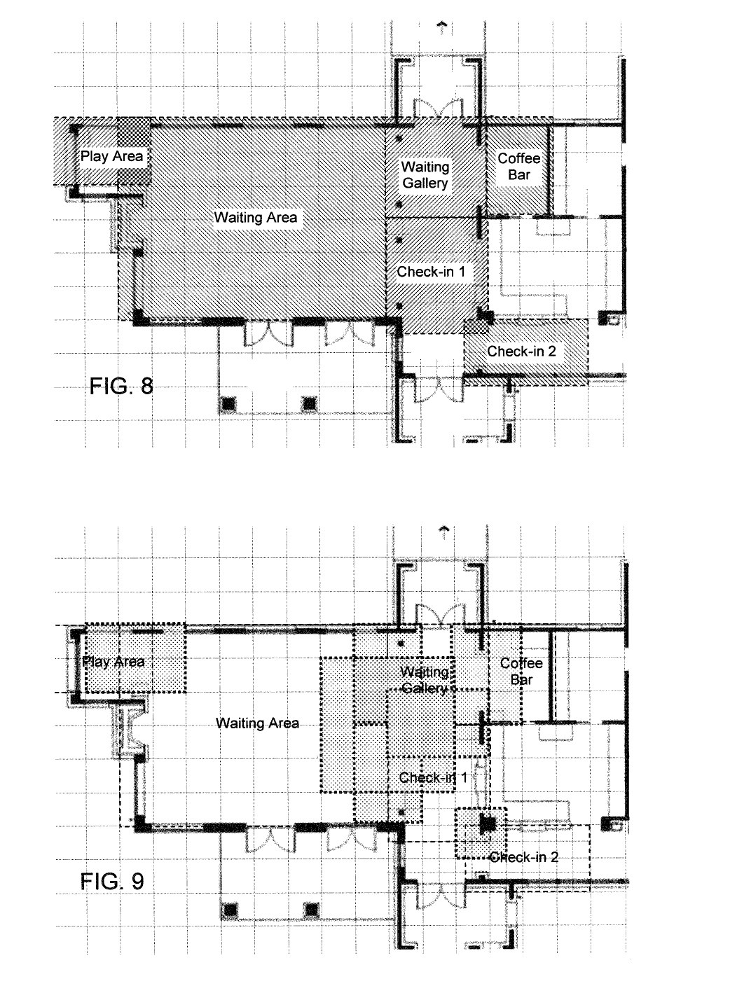

FIG. 8 illustrates an example selection of primary virtual rooms. The operator may define for instance a waiting gallery, a check-in 1, a check-in 2, a waiting area, a children's play area and a coffee bar as predetermined primary virtual rooms. As can be seen, each presented primary virtual room is composed of a selection of grid squares. All virtual rooms in FIG. 8 are rectangular, but it is to be understood that a virtual room may be any collection of squares and thus have any shape that may be composed by squares. The squares do not even have to be connected.

The defined primary virtual rooms may be overlapping. In FIG. 8 for example, the virtual rooms for the waiting area and the play area have been defined in an overlapping manner, and the virtual rooms for check-in 1 and check-in 2 have been defined in an overlapping manner. A primary virtual room may also lie completely within the area of another primary virtual room.

In addition, server 300 may support a definition of interleaving virtual rooms in action 404, optionally taking account again of an input by the operator via configuration device 340. For each combination of primary virtual rooms which share a common border point, there may be a separate interleaving room.

FIG. 9 illustrates an example selection of interleaving virtual rooms. There is an interleaving virtual room for play area and waiting area, an interleaving virtual room for waiting area and waiting gallery, an interleaving virtual room for waiting area and check-in 1, an interleaving virtual room for waiting gallery and coffee bar, an interleaving virtual room for waiting gallery and check-in 1, an interleaving virtual room for check-in 1 and check-in 2, and an interleaving virtual room for waiting area, waiting gallery and check-in 1. Thus, a virtual interleaving room is defined for each combination of defined primary virtual rooms which share at least one common border point.

At least a first version of interleaving rooms may optionally be generated automatically.

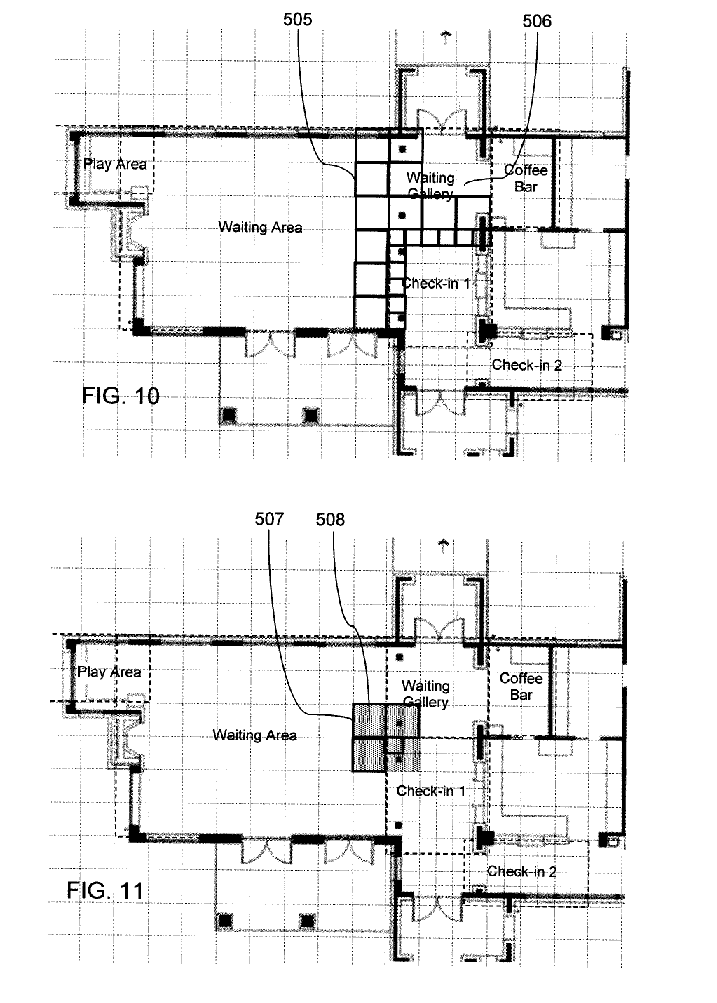

FIG. 10 illustrates a first possibility for automatically generating an interleaving virtual room. Here, every square 505 of the set of neighboring rooms virtual rooms waiting area, waiting gallery and check-in 1 is selected that touches the border of at least one of the other virtual rooms in the set. The interleaving virtual room for the set may then be determined as the minimal rectangle 506 that contains each of these squares.

It can be seen that this approach yields a rather conservative interleaving virtual room. Such a room may often be larger than necessary.

FIG. 11 illustrates an alternative possibility for automatically generating an interleaving virtual room. Here, for the interleaving virtual room 508 only those squares 507 of each primary virtual room of the previously mentioned set are selected, which touch the borders of all of the other primary virtual rooms of the set. Such an interleaving virtual room may be suitable for simple cases, but not for more complex situations in which a larger area is desired to be covered or where some primary virtual rooms for which an interleaving virtual room is to be defined do not share a common border.

Therefore, it may be provided that even if predetermined interleaving virtual rooms may be generated automatically by server 300, they may still be adjusted by the operator as needed.

In a further alternative approach for defining interleaving virtual rooms in action 404, interleaving virtual rooms may be defined to be associated with a respective arbitrary set of primary virtual rooms, for example a set of adjacent primary virtual rooms of any number. In this case, an interleaving virtual room may be associated with the set of primary virtual rooms as a whole. No shape and size has to be defined for the interleaving virtual room. The interleaving virtual room as such may simply be defined by the association with the set of primary virtual rooms, by a label and by a position on the map at which the label may be presented on a display such that it will be associated by a user with the correct set of primary virtual rooms. The label may be the same for all defined interleaving virtual room, such as “Interleaving Room”. Alternatively, separate descriptive names may be defined for different interleaving virtual room based on an input of the operator.

For overlapping primary virtual rooms, server 300 may set a priority order. The priority order may be defined by the operator via configuration device 340. The operator may select for instance a higher priority for the smaller one of two overlapping primary virtual rooms. In the example of FIG. 8, for instance, a higher priority may be assigned to the play area than to the waiting area. It would also be possible, though, to automatically assign a priority order based on the size of the overlapping primary virtual rooms.

In some embodiments, a priority order may also be assigned to interleaving virtual rooms. However, primary virtual rooms may generally be considered to be of higher priority than interleaving virtual rooms.

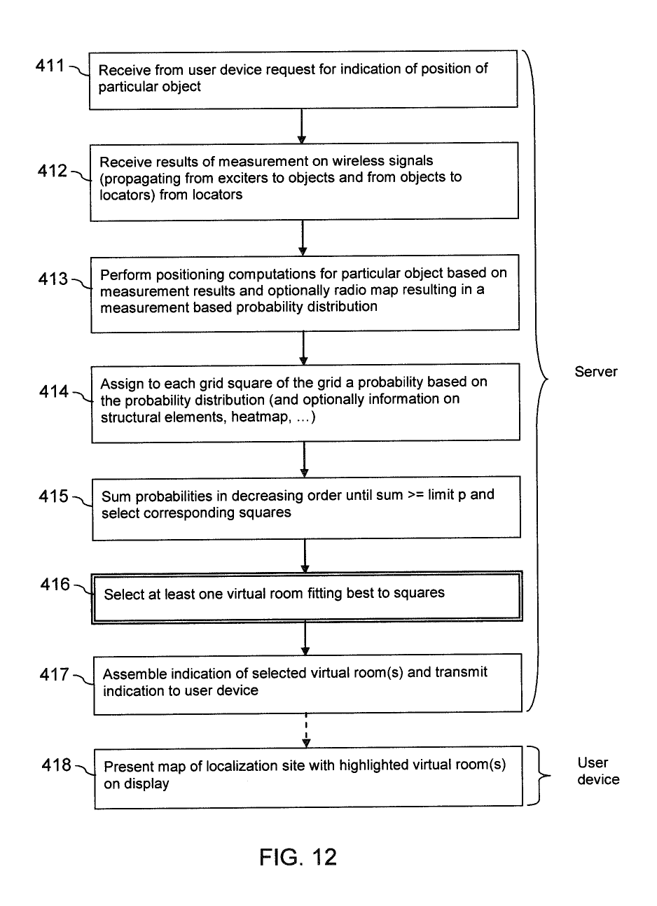

FIG. 12 is a flow chart illustrating example positioning operations at server 300. Processor 301 and some of the program code stored in memory 302 may cause server 300 to perform the presented actions when corresponding program code is retrieved from memory 302 and executed by processor 301. Only the last presented action may be performed by user device 320 instead.

When a user of user device 320 wishes to position object 310, he may cause user device 320 to transmit a corresponding positioning request to server 300. The request may include an identifier of object 310. In case server 300 is responsible for several positioning sites, the request may also include an indication of the positioning site.

Server 300 receives the request. (action 411) Object 310 may be configured to permanently scan for signals from exciters 333 and to extract an identifier of an exciter 333 or of an identifier of a room or area in which an exciter 333 is located from detected signals.

Object 310 may further be configured to regularly assemble a message including its own identifier and an indication of the identifier extracted from signals of an exciter 333 that may have been observed since the last assembly of a message. The message may be transmitted in a broadcast using a BT signaling with predefined power. In an alternative embodiment, object 310 may broadcast a message including only its identifier at regular intervals, and transmit in addition a dedicated message including current measurement results to a respective single, nearby locator 331, 332. In a further alternative embodiment, object 310 may not perform any measurements, but only broadcast a message including its identifier at regular intervals. The messages may be assembled and transmitted in short intervals, for instance once per second.

Locators 331, 332 permanently scan for BT signals from objects. Locators 331, 332 that are sufficiently close to object 310 observe the broadcast from object 310, measure the received signal strength and map it to a received signal strength indicator (RSSI), extract the identifier of object 310 and—if included—information from exciter signals detected by object 310. Optionally, locators 332 may determine in addition the angle of arrival of the signals from object 310. Alternatively, however, object 310 may include an indication in the transmitted messages that the angle of arrival is not needed.

This may simplify the subsequent combined processing of measurement results of locators 331 and 332.

Locators 331, 332 transmit their own measurement results as well as measurement results provided by object 310 to server 300.

Server 300 receives the results of measurements from the locators 331, 332. (action 412) Redundant information on exciters 333 may be deleted.

Server 300 uses the received information for performing positioning computations for object 310 in order to obtain a probability distribution for the location of object 310. Server 300 may uses to this end the radio map data stored in memory 340. (action 413)

The radio map data may assign to various positions at the positioning site a set of RSSIs corresponding to the received signal strengths that may be expected to be observed by each of locators 331, 332 when an object broadcasting signals with predefined power is located at the respective position. The radio map may have been generated for instance based on a large number of measurements all over the positioning site. The positions may correspond for instance to grid points of a grid.

Server 300 may therefore compare the RSSIs received from various locators 331, 332 for object 310 with the sets of RSSIs assigned to different positions by the radio map data. The smaller the difference, the higher the probability that object 310 is located at the position. There may be a predefined mapping of difference values to probabilities.

The determined probabilities may further be adjusted based on additional information, as far as available. For example, if the information received from locators 331, 332 indicates a certain observed angle of arrival of signals from object 310 at one or more locators 332, this information may be used for adjusting the probabilities. For example, if the information received from locators 331, 332 indicates that object 310 was able to observe signals from an exciter 333 in a particular physical room as identified by an identifier of the room or area or of the exciter 333, the probabilities in this room may be weighted higher than in other rooms. For example, if building information is available, this may also be taken into account for adjusting the probabilities, for instance if such building information indicates that some areas are not accessible. For example, if a heat map is available, which indicates common movement paths on the site, the probabilities in more frequented areas may be weighted somewhat higher than the probabilities in less frequented areas.

Based on the result of the comparison and possible adjustments, server 300 assigns to each grid square of the grid defined in actions 402 and 403 a probability value between 0 and 1 that the object is located in that square. The sum of the probabilities may be required to be lower than or equal to one, which may be achieved by a suitable, identical scaling for all probabilities. (action 414) By default, a value of zero may be assigned to all grid squares. Thus, only values greater than zero (or greater than some predetermined low threshold value) have to be assigned.

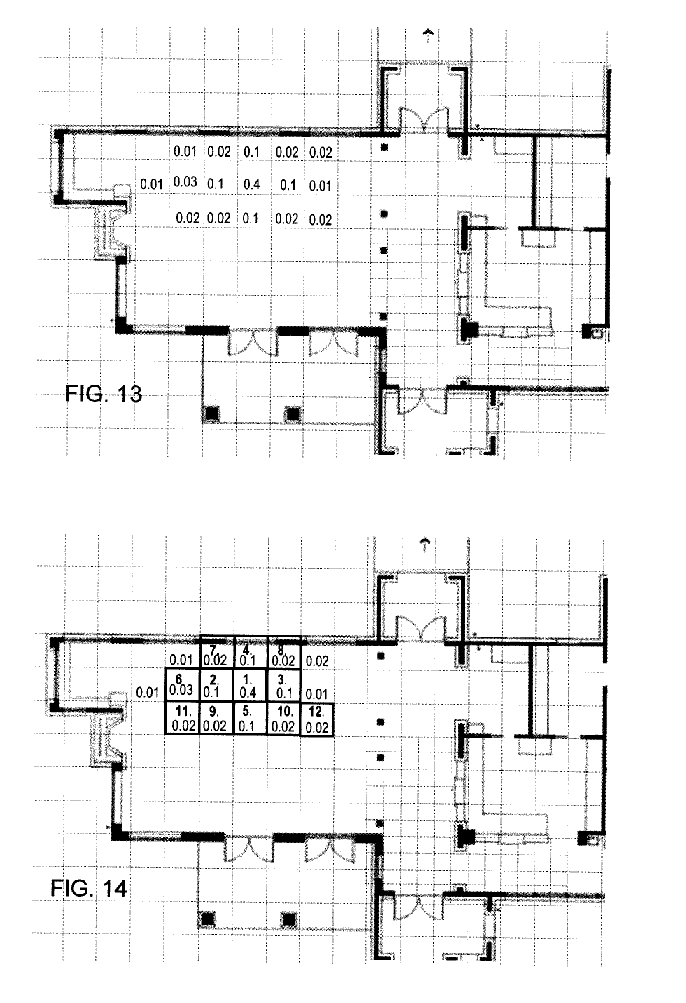

FIG. 13 illustrates an example of probability values varying between 0.4 and 0.01 that have been assigned to grid squares.

Server 300 then sums the probabilities in decreasing order, until the sum is equal to or larger than the probability limit p as determined in action 401, and selects the corresponding squares for further consideration. (action 415) In case the same probability value has been assigned to several squares, the order of summing may be arbitrary. It is possible, though, to select at first the squares which are closest to the square with the largest assigned probability. As mentioned before, grid areas may also be selected using some other approach such that the total probability assigned to the selected grid areas at least reaches a predetermined probability.

In case different limits of probability have been assigned to different areas of the positioning site, the probability for the area from in which squares have a probability larger than zero may be used. If several limits of probability are defined for such an area, for instance one for each of multiple virtual rooms, for example an average value, a minimum value or a maximum value may be used.

FIG. 14 illustrates an exemplary order of summing probabilities with a predetermined limit of p=0.95 for the assigned probabilities indicated in FIG. 13. The probabilities of twelve squares are summed and the order is indicated by ordinal numbers 1 to 12, while the associated selected squares are highlighted by fat outlines. As can be seen in the example, there are seven squares with an assigned probability value of 0.02. Four of them are (diagonal) neighbors of the square to which the largest probability value of 0.4 was assigned, while the three other squares are further away. In this case, the probabilities assigned to the four squares which are closest may be selected first for summing (ordinal numbers 7 to 10), while the selection order for further squares may be selected arbitrarily (ordinal numbers 11 and 12) until the predetermined limit of 0.95 has been reached.

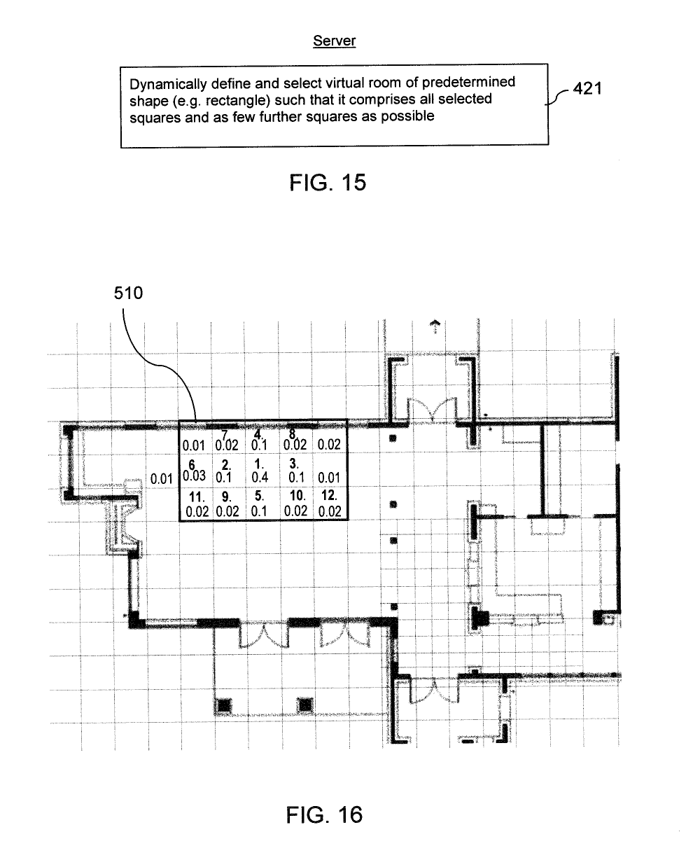

Server 300 may now select at least one virtual room fitting best to the selection of squares. (action 416) Some options for this action will be presented further below with reference to FIGS. 15, 19, 25 and 28.

Server 300 assembles an indication of the selected virtual room or rooms and transmits the indications to user device 320. (action 417)

User device 320 presents a map of the positioning site on a display and highlights the selected virtual room or rooms as estimated location of object 310 in the map. (action 418) The map may be provided to user device 320 by server 300 as well. As a result, a user knows where object 310 may likely be found and if desired, the user may look for object 320 in the indicated area. Alternatively or in addition to an immediate presentation of the positioning site on a display, the received indication may also be coupled to other functions, which process the indication. For instance, it may be coupled to the triggering of an alert, if the indicated location is determined to be outside of a defined geofence. Optionally, in this case the map of the positioning site with highlighted selected virtual room or rooms as probable location of object 310 may only be presented in the case of an alert.

Depending on the request of the user received at server 300 in action 411, the location of object 310 may be estimated only once or repeatedly until further notice. In the latter case, actions 412 to 418 may be repeated in a loop, until the user indicates to server 300 that the process may be stopped.

The operations of FIG. 12 may be or belong to an example embodiment of a method according to the invention.

FIG. 15 is a flow chart illustrating a first implementation option for selecting at least one virtual room in action 416 of FIG. 12. This option is provided for the case that no virtual rooms are predefined by the operator in actions 404 and 405 of FIG. 5. Instead, virtual rooms are generated dynamically on a general basis.

More specifically, server 300 may dynamically define and select a virtual room of predetermined shape such that it comprises all selected squares and as few further squares as possible. (action 421) The predetermined shape may be for instance a rectangle, but any other shape may be predetermined as well.

FIG. 16 illustrates an exemplary dynamic definition of a virtual room when squares 1 to 12 of FIG. 14 have been selected in action 415 of FIG. 12. It can be seen that the smallest possible rectangle 510 comprises the selected squares and three further squares, so this rectangle may be defined as virtual room in action 421 of FIG. 15.

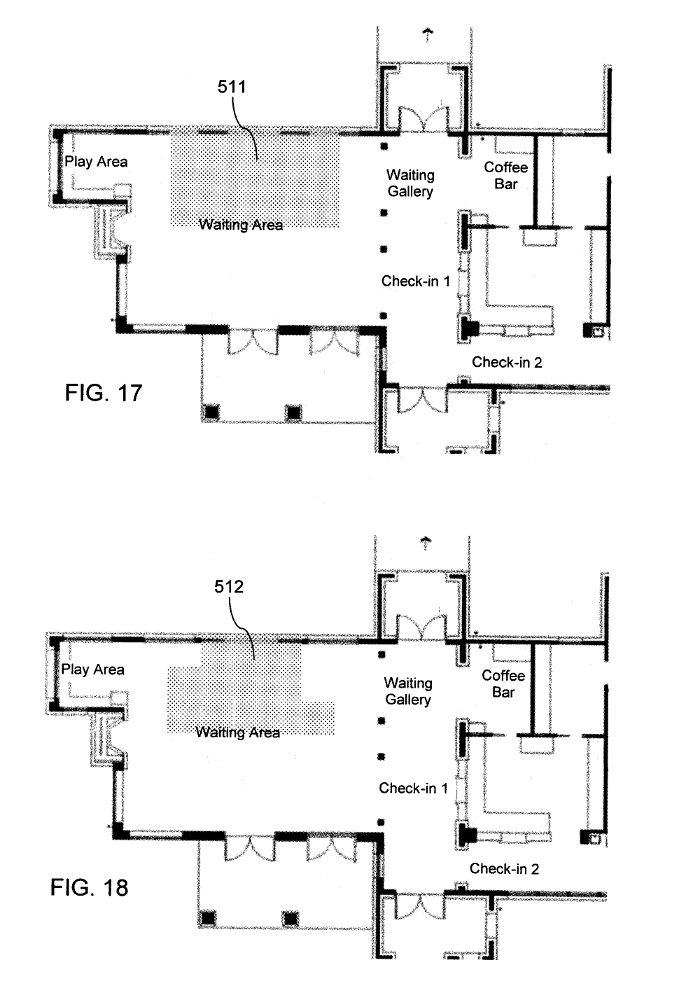

FIG. 17 illustrates an example of a presentation on a display of user device 320 for this case as a result of action 418 of FIG. 12, the presentation highlighting a corresponding virtual room 511.

In a variation, the dynamically defined virtual room does not have to be of predefined shape. It may also be simply a combination of all selected squares, even if this may result in a virtual room with irregular shape.

FIG. 18 illustrates an example of a presentation on a display of user device 320 for this case as a result of action 418 of FIG. 12, the presentation highlighting a virtual room 512 that does not have a predetermined shape but that is based instead on a combination of selected squares 1 to 12 of FIG. 14.

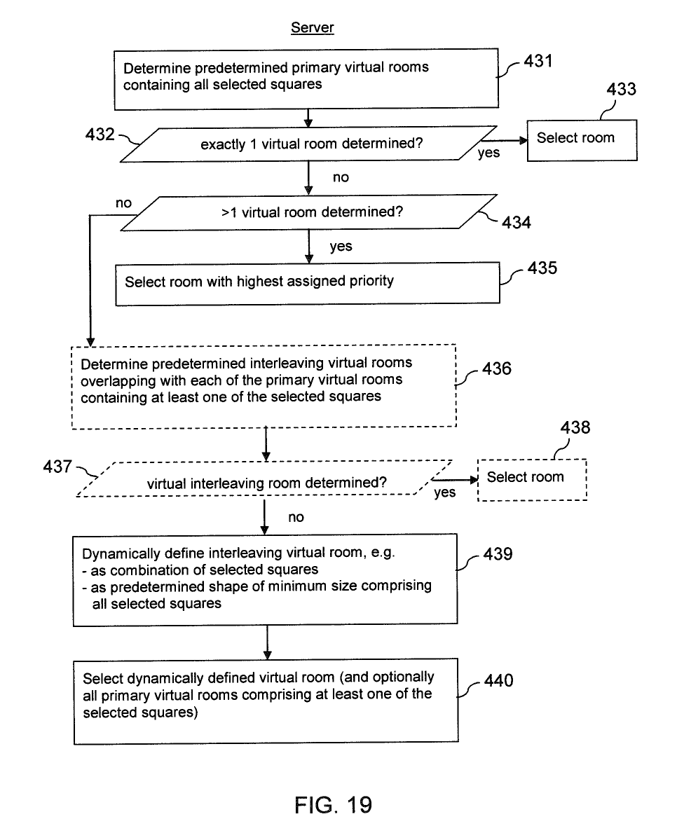

FIG. 19 is a flow chart illustrating a second implementation option for selecting at least one virtual room in action 416 of FIG. 12. This option is provided for the case that at least primary virtual rooms are predefined by the operator in actions 404 and 405 of FIG. 5.

Server 300 determines all predetermined primary virtual rooms containing all squares selected in action 415. (action 431)

In case exactly one predetermined primary virtual room is determined, this room constitutes the selected virtual room. (actions 432, 433)

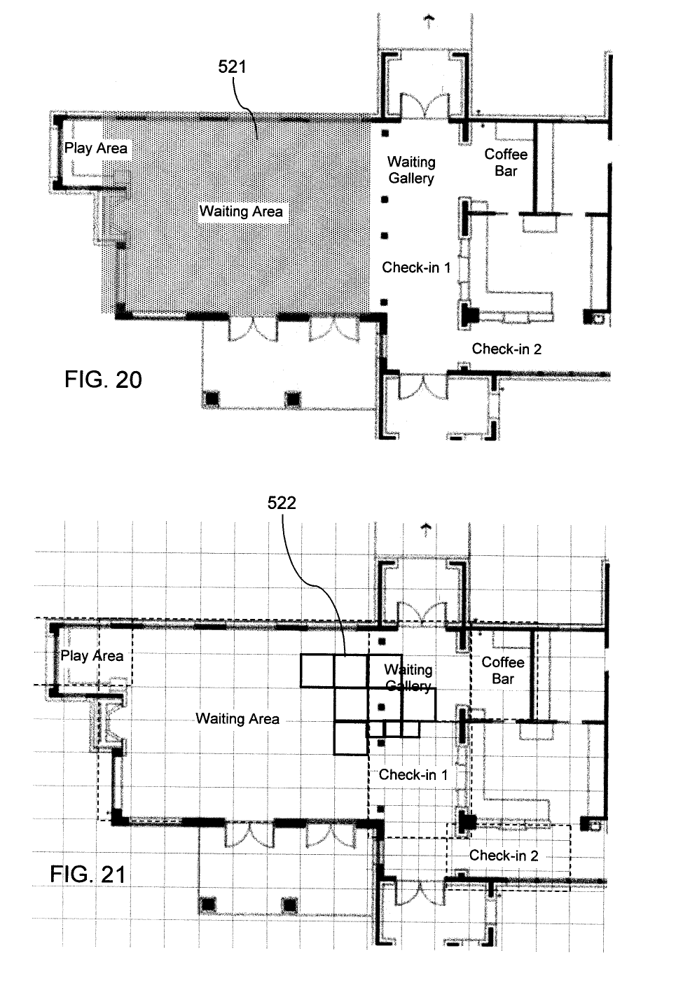

FIG. 20 illustrates an example of a presentation on a display of user device 320 for this case as a result of action 418 of FIG. 12, the presentation highlighting the waiting area as a primary virtual room 521 that may be determined and selected based on selected squares 1 to 12 of FIG. 14.

In case more than one predetermined primary virtual room is determined, the room with the highest assigned priority is selected. (actions 432, 434, 435) For example, if all selected squares are included in the waiting area and in the play area, the play area may be selected as virtual room and highlighted in a presentation. In a possible variation, all predetermined primary virtual rooms comprising all selected squares may be selected in combination for presentation.

In case no single predetermined primary virtual room comprising all selected squares is determined, server 300 may check at first whether there is a predetermined interleaving virtual room which overlaps with all of the predetermined primary virtual rooms containing at least one of the selected squares. (actions 432, 434, 436)

In case such a predetermined interleaving virtual room is determined, this room may constitute the selected virtual room. (actions 437, 438) Actions 436, 437 and 438 are optional and may be omitted in some embodiments.

In case no single predetermined primary virtual room comprising all selected squares is determined (and—in some embodiments—no predetermined interleaving virtual room either), server 300 dynamically defines an interleaving virtual room. Such a dynamically defined interleaving virtual room may be a combination of the selected squares or a room of predetermined shape and minimum size comprising all selected squares. (actions 432, 434, 437, 439)

Server 300 may then select this dynamically defined interleaving virtual room as virtual room. (action 440) It is to be understood that this selection does not have to be a separate step; rather the interleaving room dynamically defined in action 439 may be considered to be selected.

FIG. 21 illustrates a situation in which squares 522 have been selected in action 415 of FIG. 12 that are not contained completely in at least one predetermined primary virtual room. Furthermore, no interleaving virtual rooms may have been predetermined, or no suitable interleaving virtual room for this selection of squares 522 may have been predetermined. The latter may be the case, for instance, if interleaving virtual rooms have only been predetermined for all possible pairs of the defined primary virtual rooms, but not for any combination of three or more defined primary virtual rooms.

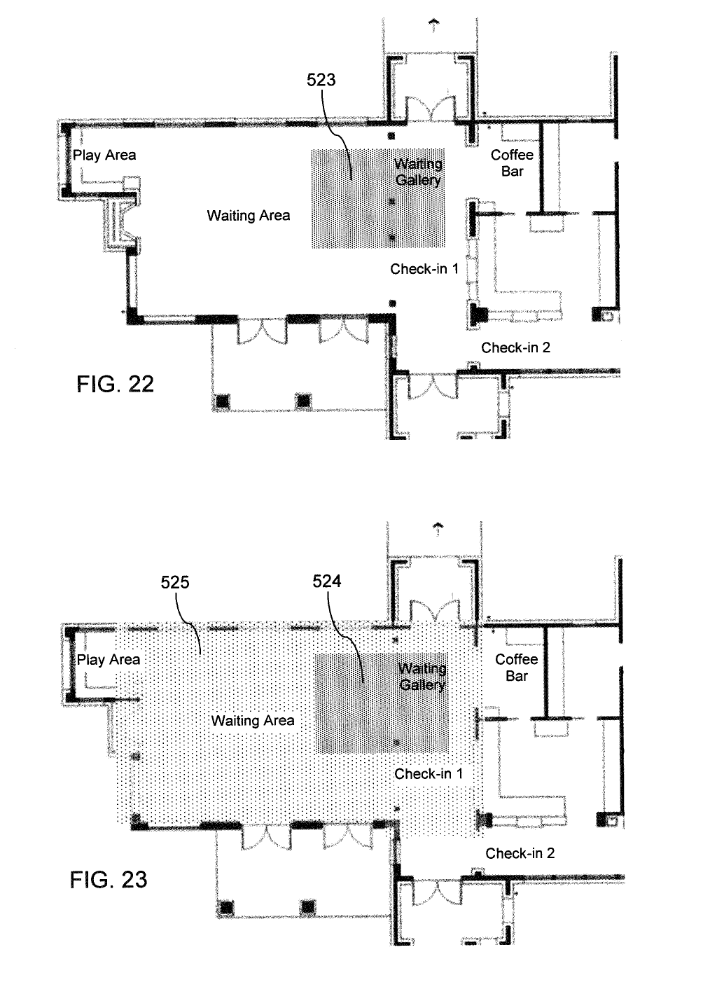

FIG. 22 illustrates an example of a presentation on a display of user device 320 for this case as a result of action 418 of FIG. 12, the presentation highlighting an interleaving room 523 that is dynamically defined in action 439 based on the selected squares 522 of FIG. 21 and selected for presentation in action 439.

Optionally, all primary virtual rooms comprising at least some of the selected squares may be selected as additional virtual rooms for presentation in action 440.

FIG. 23 illustrates a corresponding variation of the example presentation of FIG. 22. Here, in addition to the dynamically generated interleaving virtual room 524, in addition all predetermined primary virtual rooms 525 comprising at least one of the selected squares 522 of FIG. 21 are highlighted, namely waiting area, waiting gallery and check-in 1. The manner of presentation may enable the user to differentiate between the highlighted interleaving virtual room 524 and the highlighted primary virtual rooms 525.

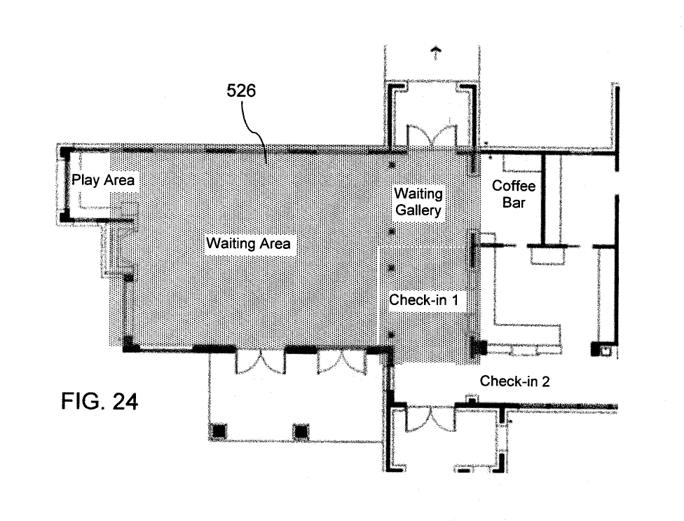

An example variation of the option presented in FIG. 19 does not make use of interleaving virtual rooms in the first place. Instead, all predetermined primary virtual rooms which contain at least one of the squares selected in action 415 are determined and selected for presentation. This is illustrated in FIG. 24, in which only predetermined primary virtual rooms 526 comprising at least one of the selected squares 522 of FIG. 21 are highlighted, namely waiting area, waiting gallery and check-in 1.

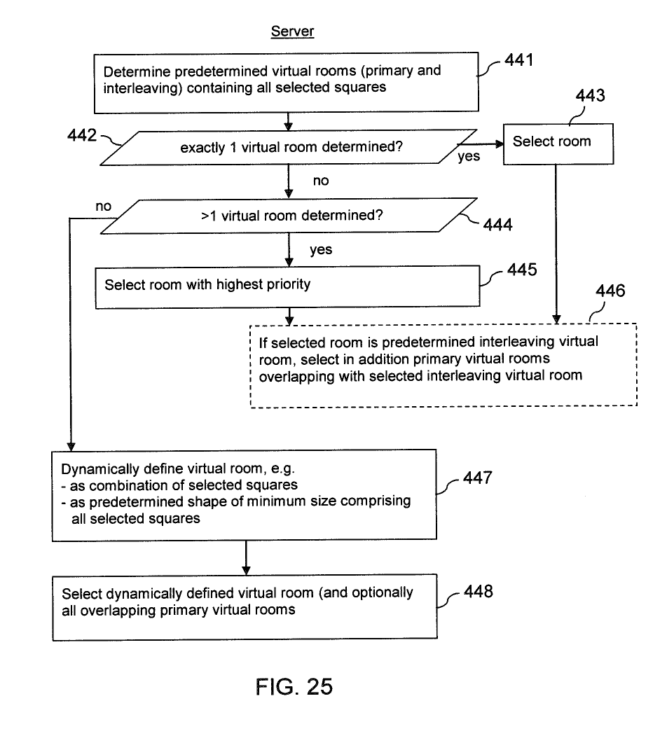

FIG. 25 is a flow chart illustrating a third implementation option for selecting at least one virtual room in action 416 of FIG. 12. This option is provided for the case that primary and interleaving virtual rooms are predefined by the operator in actions 404 and 405 of FIG. 5. In this case, a dynamic generation of virtual rooms may only be needed in fairly rare situations.

Server 300 determines all predetermined primary and interleaving virtual rooms containing all squares selected in action 415. (action 441)

In case exactly one predetermined virtual room is determined, this room constitutes a selected virtual room. (actions 442, 443) An indication of the selected virtual room may be provided for presentation in the scope of action 418 of FIG. 12.

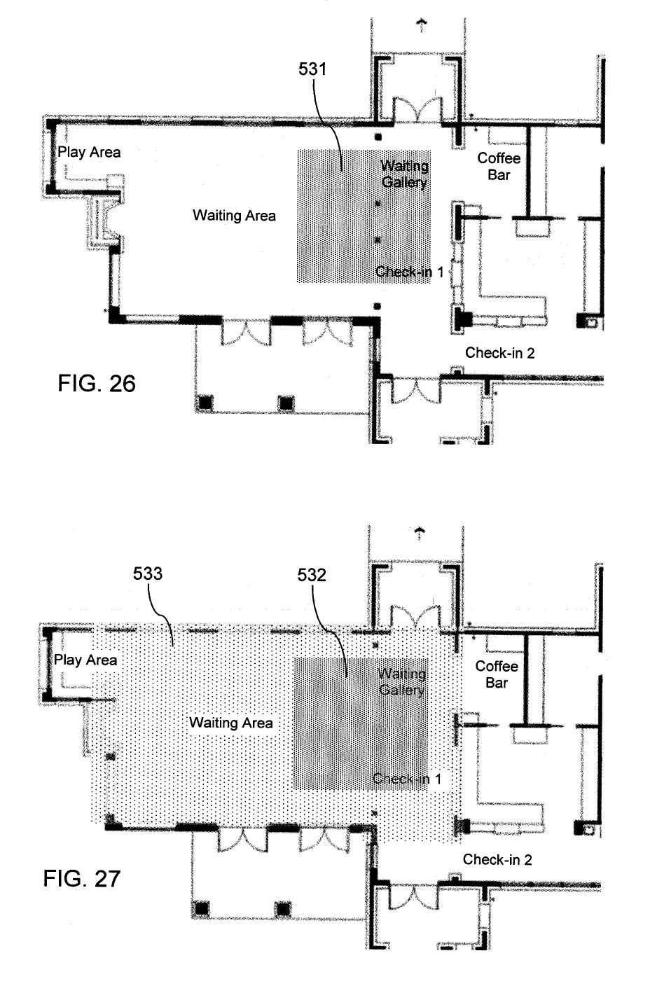

FIG. 26 illustrates an example of a presentation on a display of user device 320 for this case as a result of action 418 of FIG. 12, the presentation highlighting a predetermined interleaving virtual room 531 that may be determined and selected in action 443 based on selected squares 522 of FIG. 21. The predetermined interleaving virtual room 531 may correspond to the predetermined interleaving room between waiting area, waiting gallery and check-in 1 illustrated in FIG. 9.

In case more than one predetermined primary or interleaving virtual room, each comprising all selected squares, is determined, the room with the highest assigned priority is selected. (actions 442, 444, 445) An indication of the selected virtual room may be provided for presentation in the scope of action 418 of FIG. 12.

In case a predetermined interleaving virtual room is selected in action 443 or 445, it is a possible variation to select in addition primary virtual rooms overlapping with the selected interleaving virtual room. (action 446) An indication of the selected predetermined interleaving virtual room and of the selected set of predetermined primary virtual rooms may then be provided for presentation in the scope of action 418 of FIG. 12.

FIG. 27 illustrates an example of a presentation on a display of user device 320 for this case as a result of action 418 of FIG. 12, the presentation highlighting a selected, predetermined interleaving virtual room 532 (by way of example the same as in FIG. 26) and in addition selected primary virtual rooms 533 overlapping with the selected interleaving virtual room 532, namely waiting area, waiting gallery and check-in 1.

In case no single predetermined primary or interleaving virtual room comprising all selected squares is determined, server 300 dynamically defines an interleaving virtual room. Such a dynamically defined interleaving virtual room may again be a combination of the selected squares or a room of predetermined shape and minimum size comprising all selected squares. (actions 442, 444, 447) Server 300 may then select this dynamically defined interleaving virtual room as virtual room for presentation in the scope of action 418 of FIG. 12. (action 448) Again, optionally, all primary virtual rooms comprising at least some of the selected squares may be selected as additional virtual rooms for presentation in action 448.

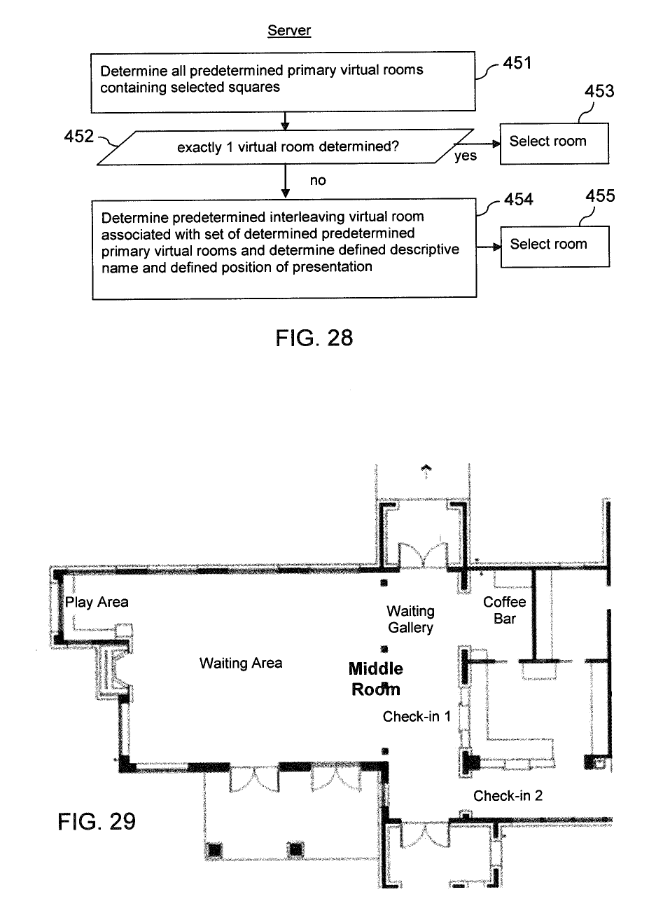

FIG. 28 is a flow chart illustrating a fourth implementation option for selecting at least one virtual room in action 416 of FIG. 12. This option is provided for the case that primary and interleaving virtual rooms are predefined by the operator in actions 404 and 405 of FIG. 5. In this case, however, the interleaving rooms have not been defined as comprising a particular shape, but only in terms of a respective set of primary virtual rooms with which they are associated, a descriptive name and a position on a map at which the descriptive name may be displayed.

Server 300 determines all predetermined primary virtual rooms containing squares that have been selected in action 415. (action 451)

In case exactly one predetermined virtual room is determined that contains the selected squares, this room constitutes a selected virtual room. (actions 452, 453) An indication of the primary virtual room may be provided for presentation in the scope of action 418 of FIG. 12. If the selected squares correspond for instance to squares 1 to 12 presented in FIG. 14, the presentation of the determined primary virtual room may correspond for instance to the presentation illustrated in FIG. 20, in which the waiting area has been highlighted as selected primary virtual room 521.

In case more than one predetermined primary virtual room is determined in action 451, server 300 determines in addition an interleaving virtual room that is associated with the set of predetermined primary virtual rooms which contain each at least one of the squares selected in action 415. (actions 452, 454) The determined interleaving virtual room may be selected for presentation in the scope of action 418 of FIG. 12.

FIG. 29 illustrates an example presentation of such an intermediate virtual room that may be determined in the case squares 522 presented in FIG. 21 are selected. The example descriptive name “Middle Room” may be defined to be presented at a position that may be associated by a user with the combination of waiting area, waiting gallery and check-in 1. The descriptive name may be particularly highlighted. In FIG. 29 it is highlighted by bold letters and larger scale, but on a user display it may be highlighted in many other ways, like a particular color, a colored background, by blinking, etc.

Obviously, such an interleaving virtual room may also be displayed with some shape instead of or in addition to a label. The displayed shape may be independent of selected squares and of the grid structure.

Obviously, the process of FIG. 28 may be refined with similar details as other presented example embodiments, for instance by considering assigned priorities, by dynamically generating an interleaving virtual room when needed, etc.

It is to be understood that the presented example systems, apparatuses and operations may be varied in many ways. The system and the apparatuses may be varied for instance by modifying, omitting and/or adding components. The operations may be varied for instance by modifying actions, by omitting actions and/or by adding actions. In addition, the order of actions may be modified.

In the system of FIG. 3, for example, exciters 333 and/or locators 332 may be omitted. Furthermore, for example, locators 331 and/or locators 332 may support a WLAN communication instead of a Bluetooth communication. Accordingly, object 310 may support a WLAN communication for communicating with locators 331, 332 instead of a Bluetooth communication.

Furthermore, for example, the signals between object 310 and locators 331, 332 may also be transmitted in the opposite direction. In this case, object 310 may perform measurements on signals from locators 331, 332 to determine for instance an identifier of each observed locator 331, 332 and an associated received signal strength value. Object 310 may then provide the measurement results to server 300 via one of locators 331, 332 or via a different link, for instance via a separate WLAN access node.

Furthermore, for example, radio map data may also be stored at a different entity than server 300.

Furthermore, for example, action 401 of FIG. 5 may also be performed after any of actions 402 to 405.

Furthermore, for example, it is to be understood that the positioning computations for determining a probability distribution in action 413 of FIG. 12 do not have to make use of a radio map. Instead, any positioning computations may be used which do not—at least at an intermediate stage—determine a single definite location of an object that is to be located, but rather (at least conceptually) a probability distribution over possible locations. The positioning computations may be based, for instance, on a path loss model for object 310. A received signal strength at a locator 331, 332 may then indicate for example radiuses around locator 331, 332 at which object 310 is located with different probabilities, and the result for several locators 331, 332 may be combined to a single probability distribution.

Furthermore, for example, server 300 may be responsible in addition for assembling radio map data.

Furthermore, for example, actions 411 to 417 of FIG. 12 do not have to be carried out by a server. The received information may equally be provided to user device 320, for instance via some server, and user device 320 may then take care of the operations. The actions may also be performed by object 310 to obtain an estimate of its own location. The indication of at least one selected virtual room may be transmitted to user device 320 or be used for informing a user of object 310 directly about the at least one selected virtual room.

Summarized, certain embodiments of the invention support an alternative to a conventional presentation of location information in the form of a highlighted physical room or a dot with accuracy indicated by the size of a surrounding circle. In particular with at least partially less accurate indoor positioning possibilities, the supported kind of presentation may be suited to provide useful information to a user. The presented approach may be particularly suited for indoor positioning, but is also applicable for other positioning sites which may have mixed indoor and outdoor spaces or even only outdoor spaces.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)

(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Any of the memories mentioned in this text could be implemented as a single memory or as a combination of a plurality of distinct memories, and may comprise for example a read-only memory (ROM), a random access memory (RAM), a flash memory or a hard disc drive memory etc.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

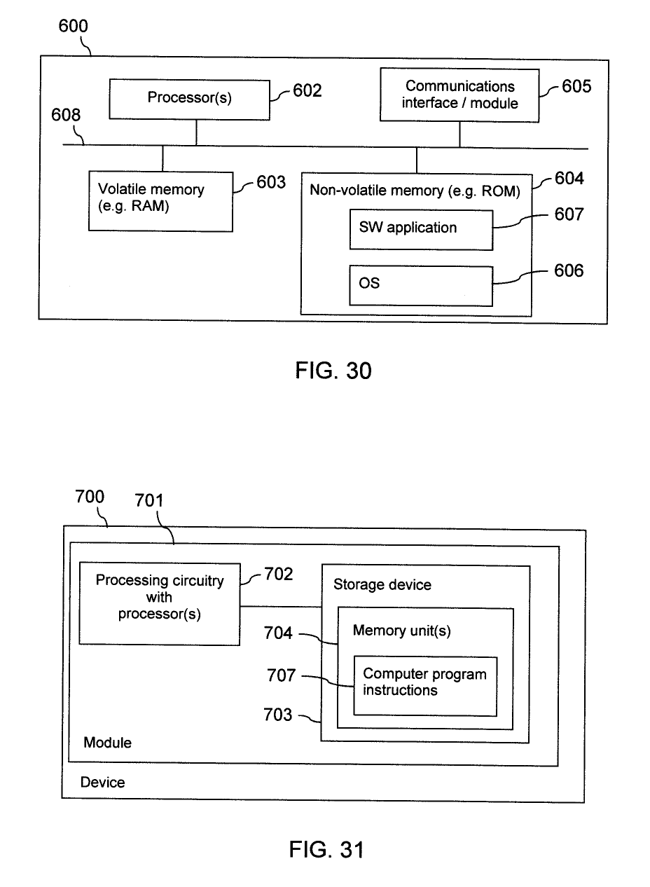

Example embodiments using at least one processor and at least one memory as a non-transitory data medium are shown in FIGS. 30 and 31.

FIG. 30 is a schematic block diagram of a device 600. Device 600 includes a processor 602. Processor 602 is connected to a volatile memory 603, such as a RAM, by a bus 608. Bus 608 also connects processor 602 and RAM 603 to a non-volatile memory 604, such as a ROM. A communications interface or module 605 is coupled to bus 608, and thus also to processor 602 and memories 603, 604. Within ROM 604 is stored a software (SW) application 607. Software application 607 may be a positioning application, although it may take some other form as well. An operating system (OS) 606 also is stored in ROM 604.

FIG. 31 is a schematic block diagram of a device 700. Device 700 may take any suitable form. Generally speaking, device 700 may comprise processing circuitry 702, including one or more processors, and a storage device 703 comprising a single memory unit or a plurality of memory units 704. Storage device 703 may store computer program instructions 707 that, when loaded into processing circuitry 702, control the operation of device 700. Generally speaking, also a module 701 of device 700 may comprise processing circuitry 702, including one or more processors, and storage device 703 comprising a single memory unit or a plurality of memory units 704. Storage device 703 may store computer program instructions 707 that, when loaded into processing circuitry 702, control the operation of module 701.

The software application 607 of FIG. 30 and the computer program instructions 707 of FIG. 31, respectively, may correspond e.g. to the computer program code in any of memories 102 and 302, respectively.

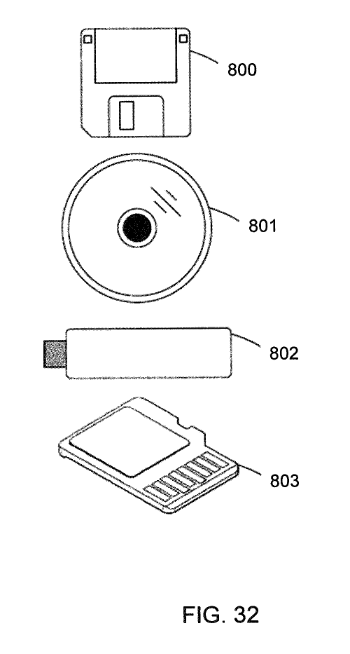

In example embodiments, any non-transitory computer readable medium mentioned in this text could also be a removable/portable storage or a part of a removable/portable storage instead of an integrated storage. Example embodiments of such a removable storage are illustrated in FIG. 32, which presents, from top to bottom, schematic diagrams of a magnetic disc storage 800, of an optical disc storage 801, of a semiconductor memory circuit device storage 802 and of a Micro-SD semiconductor memory card storage 803.

The functions illustrated by processor 101 in combination with memory 102, or processor 301 in combination with memory 302, or component 303 can also be viewed as means for assigning to a plurality of grid areas of a grid, the grid defined to virtually cover a positioning site, a probability that an object is located in the respective grid area, the probabilities being based at least on characteristics of wireless signals propagating in at least one direction between the object and devices distributed at the positioning site; means for selecting grid areas such that the total probability assigned to the selected grid areas at least reaches a predetermined probability; means for determining a set of at least one virtual room, with the set containing selected grid areas; and means for providing an indication of the set of at least one virtual room as an estimated location of the object.

The program codes in memory 102 and memory 302 can also be viewed as comprising such means in the form of functional modules.

FIGS. 2, 5, 12, 15, 19, 25 and 28 may also be understood to represent example functional blocks of computer program codes for supporting an indication of a location of an object.

It will be understood that all presented embodiments are only examples, and that any feature presented for a particular example embodiment may be used with any aspect of the invention on its own or in combination with any feature presented for the same or another particular example embodiment and/or in combination with any other feature not mentioned. It will further be understood that any feature presented for an example embodiment in a particular category may also be used in a corresponding manner in an example embodiment of any other category.

1-29. (canceled)

30. A method comprising:
assigning to a plurality of grid areas of a grid, the grid defined to virtually cover a positioning site, a probability that an object is located in the respective grid area, the probabilities being based at least on characteristics of wireless signals propagating in at least one direction between the object and devices distributed at the positioning site;
selecting the grid areas such that the total probability assigned to the selected grid areas at least reaches a predetermined probability;
determining a set of at least one virtual room, with the set comprising selected grid areas; and
providing an indication of the set of at least one virtual room as an estimated location of the object.

31. A method according to claim 30, wherein:
the virtual room is defined by selecting at least one or more square areas from a larger room or space at the positioning site.

32. The method according to claim 30, wherein selecting the grid areas such that the total probability assigned to the selected grid areas at least reaches a predetermined probability comprises:
selecting a minimum number of grid areas for which the sum of the assigned probabilities is one of larger than a predetermined limit and equal to or larger than a predetermined limit; and/or
summing the probabilities assigned to grid areas in decreasing order of probability until the sum of the probabilities is one of larger than a predetermined limit and equal to or larger than a predetermined limit, and selecting the grid areas of which the probabilities have been summed.

33. The method according to claim 30, further comprising causing the determined set of at least one virtual room to be indicated to a user as an estimated location of the object.

34. The method according to claim 30, wherein the determined set of at least one virtual room comprises at least one virtual room of the following set of virtual rooms:
at least one predetermined virtual room;
at least one dynamically determined virtual room;
at least one virtual room predetermined manually by a user to correspond to an area of the positioning site comprising a distinctive characteristic;
at least one predetermined interleaving virtual room associated with a set of at least two primary virtual rooms, the at least two primary virtual rooms corresponding to a respective area of the positioning site comprising a distinctive characteristic;
at least one interleaving virtual room predetermined manually by a user, the at least one interleaving virtual room covering at least a part of each of at least two adjacent primary virtual rooms, the at least two adjacent primary virtual rooms corresponding to a respective area of the positioning site comprising a distinctive characteristic;
at least one virtual room dynamically determined as a combination of all selected grid areas; and
the virtual room dynamically determined as an area of predetermined shape comprising all selected grid areas;
wherein the interleaving virtual room is an overlapping area of at least two adjacent primary virtual rooms.

35. An apparatus comprising at least one processor and at least one memory including computer program code, the at least one memory and the computer program code configured to, with the at least one processor, cause at least one apparatus to perform at least the following:
assign to a plurality of grid areas of a grid, the grid defined to virtually cover a positioning site, a probability that an object is located in the respective grid area, the probabilities being based at least on characteristics of wireless signals propagating in at least one direction between the object and devices distributed at the positioning site;
select the grid areas such that the total probability assigned to the selected grid areas at least reaches a predetermined probability;
determine a set of at least one virtual room, with the set comprising selected grid areas; and
provide an indication of the set of at least one virtual room as an estimated location of the object.

36. The apparatus according to claim 35, wherein:
the virtual room is defined by selecting at least one or more square areas from a larger room or space at the positioning site.

37. The apparatus according to claim 35, wherein selecting the grid areas such that the total probability assigned to the selected grid areas at least reaches a predetermined probability comprises:
selecting a minimum number of grid areas for which the sum of the assigned probabilities is one of larger than a predetermined limit and equal to or larger than a predetermined limit; and/or
summing the probabilities assigned to grid areas in decreasing order of probability until the sum of the probabilities is one of larger than a predetermined limit and equal to or larger than a predetermined limit, and selecting the grid areas of which the probabilities have been summed.

38. The apparatus according to claim 35, wherein the at least one memory and the computer program code are further configured to, with the at least one processor, cause the at least one apparatus to cause the determined set of at least one virtual room to be indicated to a user as an estimated location of the object.

39. The apparatus according to claim 35, wherein the determined set of at least one virtual room comprises at least one virtual room of the following set of virtual rooms:
at least one predetermined virtual room;
at least one dynamically determined virtual room;
at least one virtual room predetermined manually by a user to correspond to an area of the positioning site comprising a distinctive characteristic;
at least one predetermined interleaving virtual room associated with a set of at least two primary virtual rooms, the at least two primary virtual rooms corresponding to a respective area of the positioning site comprising a distinctive characteristic;
at least one interleaving virtual room predetermined manually by a user, the at least one interleaving virtual room covering at least a part of each of at least two adjacent primary virtual rooms, the at least two adjacent primary virtual rooms corresponding to a respective area of the positioning site comprising a distinctive characteristic;
at least one virtual room dynamically determined as a combination of all selected grid areas; and
the virtual room dynamically determined as an area of predetermined shape comprising all selected grid areas.
wherein the interleaving virtual room is an overlapping area of at least two adjacent primary virtual rooms.

40. The apparatus according to claim 39,
wherein at least two primary virtual rooms corresponding to a respective area of the positioning site comprising a distinctive characteristic have been predetermined;
wherein determining a set of at least one virtual room, with the set comprising selected grid areas, comprises determining whether one of the predetermined primary virtual rooms comprises all selected grid areas, and if it is determined that none of the predetermined primary virtual rooms comprises all selected grid areas, dynamically generating an interleaving virtual room comprises all selected grid areas; and
wherein, in case the interleaving virtual room is dynamically generated, providing an indication of the set of at least one virtual room as an estimated location of the object comprises providing at least an indication of the dynamically generated interleaving virtual room as an estimated location of the object.

41. The apparatus according to claim 39,
wherein at least two primary virtual rooms corresponding to a respective area of the positioning site comprising a distinctive characteristic have been predetermined and wherein at least one interleaving virtual room comprising at least parts of at least two of the at least two primary virtual rooms has been predetermined;
wherein determining a set of at least one virtual room, with the set comprising selected grid areas, comprises determining whether one of the predetermined virtual rooms comprises all selected grid areas, and if it is determined that none of the predetermined virtual rooms comprises all selected grid areas, dynamically generating the interleaving virtual room comprising all selected grid areas; and
wherein, in case the interleaving virtual room is dynamically generated, providing an indication of the set of at least one virtual room as an estimated location of the object comprises providing at least an indication of the dynamically generated interleaving virtual room as an estimated location of the object.

42. The apparatus according to claim 39,
wherein at least two primary virtual rooms corresponding to a respective area of the positioning site comprising a distinctive characteristic have been predetermined and wherein at least one interleaving virtual room comprising at least parts of at least two of the at least two primary virtual rooms has been predetermined; and
wherein determining a set of at least one virtual room, with the set comprising selected grid areas, and providing an indication of the set of at least one virtual room as an estimated location of the object comprises:
determining whether one of the predetermined primary virtual rooms comprises all selected grid areas,
if none of the predetermined primary virtual rooms comprises all selected grid areas, determining whether the interleaving virtual room has been predetermined which comprises at least a part of each predetermined primary virtual room comprising at least one of the selected grid areas,
if it is determined that such the interleaving virtual room has been predetermined, providing at least an indication of the predetermined interleaving room as an estimated location of the object, and
if it is determined that such the interleaving virtual room has not been predetermined, dynamically generating the interleaving virtual room, and providing at least an indication of the dynamically generated interleaving virtual room as an estimated location of the object.

43. The apparatus according to claim 39,
wherein at least two primary virtual rooms corresponding to a respective area of the positioning site comprising a distinctive characteristic have been predetermined and wherein at least one interleaving virtual room has been defined for a respective set of at least two primary virtual rooms; and
wherein determining a set of at least one virtual room, with the set comprising selected grid areas, and providing an indication of the set of at least one virtual room as an estimated location of the object comprises:
determining whether one of the predetermined primary virtual rooms comprises all selected grid areas,
if it is determined that none of the predetermined virtual rooms comprises all selected grid areas, determining whether the interleaving virtual room has been defined for a set of all primary virtual rooms comprising at least one selected grid area, and
if such an interleaving virtual room has been defined, providing an indication of the defined interleaving virtual room as an estimated location of the object.

44. The apparatus according to claim 39, wherein for the case that at least two primary virtual rooms corresponding to a respective area of the positioning site comprising a distinctive characteristic have been predetermined, that at least two of the predetermined primary virtual rooms are overlapping, that different priorities have been assigned to the predetermined overlapping primary virtual rooms, and that at least two predetermined primary virtual rooms are determined which each comprises all selected grid areas, the at least one memory and the computer program code are further configured to, with the at least one processor, cause the at least one apparatus to select the determined virtual room with the highest assigned priority.

45. The apparatus according to claim 35, wherein the grid is defined to comprise grid areas of different sizes in different regions of the positioning site.

46. The apparatus according to claim 35, wherein the probabilities are based on at least one criterion of the following set of criteria:
a radio map;
results of measurements on the wireless signals;
an angle of arrival of wireless signals;
a time-of-flight of wireless signals;
a received signal strength of wireless signals;
a signal strength pattern of wireless signals;
structural elements of the positioning site; and
a heatmap indicating a frequency at which each grid area is entered by objects.

47. The apparatus according to claim 35, wherein the wireless signals comprise:
wireless signals transmitted by the devices and received by the object; and/or
wireless signals transmitted by the object and received by the devices.

48. The apparatus according to claim 35, wherein the apparatus is one of:
a chip;
an integrated circuit;
a plug-in board;
a module for a device;
a server; and
a user device.

49. A non-transitory computer readable storage medium in which computer program code is stored, the computer program code causing at least one apparatus to perform the following when executed by a processor:
assign to a plurality of grid areas of a grid, the grid defined to virtually cover a positioning site, a probability that an object is located in the respective grid area, the probabilities being based at least on characteristics of wireless signals propagating in at least one direction between the object and devices distributed at the positioning site;
select the grid areas such that the total probability assigned to the selected grid areas at least reaches a predetermined probability;
determine a set of at least one virtual room, with the set comprising selected grid areas; and
provide an indication of the set of at least one virtual room as an estimated location of the object.
